(19) United States
(12) Patent Application Publication
(10) Pub. No.: US 2015/0212105 A1
(43) Pub. Date: Jul. 30, 2015

(54) ANALYSIS SYSTEM AND ANALYSIS METHOD

(71) Applicant: Hitachi High-Technologies Corporation, Tokyo (JP)

(72) Inventor: Takayuki Obara, Tokyo (JP)

(21) Appl. No.: 14/418,979

(22) PCT Filed: Jul. 8, 2013
(86) PCT No.: PCT/JP2013/068586

§ 371 Date: Feb. 2, 2015

(30) Foreign Application Priority Data
Aug. 3, 2012 (JP) 2012-172478

(51) Int. Cl. G01N 35/08

(52) U.S. Cl. CPC G01N 35/08

(57) ABSTRACT

Disclosed is an analysis system, in which droplets in a microfluidic device are transported to an analysis apparatus outside the microfluidic device, and are analayzed while being distinguished from each other. A flow channel of the microfluidic device and a pipeline are connected to each other using a connection portion that allows the droplets to flow in an orderly row. That is, the analysis system of the present invention includes the microfluidic device having micro flow channels, and the analysis apparatus, in which the microfluidic device has a first inlet and a second inlet, the flow channels from the inlets are confluent with each other therein, and a fluid injected via each of the inlets is discharged to the analysis apparatus. Accordingly, it is possible to transport the droplets to the analysis apparatus in an orderly row via the pipeline, and it is possible to analyze the droplets.

### TECHNICAL FIELD

The present invention relates to an analysis system and an analysis method for analyzing micro-droplets.

### BACKGROUND ART

A technique of using micro-droplets formed and manipulated in a microfluidic device has been actively studied, as a technique of handling a micro-amount of specimens and analyzing the specimens. Accordingly, a micro-amount of liquid specimens is sampled in the form of a droplet, the specimens are trapped in droplets, or various reactions are performed in droplets. In addition, a mass spectrometer has great potential as means for analyzing droplets. A mass spectrometer can detect a wide variety of types of objects without marking a target object, and has a high sensitivity required for analyzing a micro-amount of specimens.

NPL 1 discloses a technology that uses a mass spectrometer so as to detect droplets formed in a microfluidic device. The formed droplets are transported in the channel of the microfluidic device by a continuous phase of fluoric oil trapping the droplets. Before the composition of the droplet is analyzed using the mass spectrometer, this continuous phase is removed using an emulsion separation mechanism of the device. This process is realized as follows. The fluoric oil containing the droplets flows in the flow channel of the emulsion separation mechanism while being adjacent to and parallel with an aqueous lateral stream. The opposite shoulders of the flow channel are respectively provided with electrodes, and a voltage is applied to the electrodes, and thereby the droplets are fused into the aqueous lateral stream, and the composition of the droplets is extracted from the aqueous lateral stream. The flow is divided into two streams at an outlet of the emulsion separation mechanism, and only the aqueous lateral stream is delivered to the mass spectrometer from a discharge port of the device via a capillary made of fused quartz.

### CITATION LIST

### Non Patent Literature

NPL 1: Fidalgo et al. Angewandte Chemie International Edition (2009), vol. 48 pp. 3665-3668.

### SUMMARY OF INVENTION

### Technical Problem

In the technology disclosed in NPL 1, in order to detect the composition of the droplet using the mass spectrometer, it is necessary to separate the continuous phase, which transports the droplets, using the emulsion separation mechanism of the microfluidic device. This mechanism makes the structure of the microfluidic device complicated, and makes each of a design process, a manufacturing process, and an operation complicated. In addition, in the same technology, since the composition of the droplet is extracted from the aqueous lateral stream, the composition may be diluted. There is a problem in that when the length of a flow channel on a downstream side of the emulsion separation mechanism or the length of the capillary made of fused quartz increases, the droplet may diffuse in the aqueous lateral stream, and be further diluted, and it becomes difficult to detect the composition of the droplet.

An object of the present invention is to deliver droplets in a microfluidic device to an analysis apparatus via a simple structure, while the droplets are not separated from a continuous phase.

### Solution to Problem

A system of the present invention is an analysis system that includes a micro device having micro flow channels, and an analysis apparatus. The micro device has a first inlet and a second inlet, the flow channels from the inlets are confluent with each other therein, and a fluid injected via each of the inlets is discharged to the analysis apparatus.

### Advantageous Effects of Invention

According to the present invention, the fluid injected via the first inlet divides the fluid via the second inlet in the device, that is, one of the fluids divides the other of the fluids, and thereby it is possible to extract droplets from a microfluidic device in an orderly row. Accordingly, it is possible to deliver the droplets to the analysis apparatus using a simple structure and a simple method, and to analyze the droplets.

### BRIEF DESCRIPTION OF DRAWINGS

FIG. 1 is a schematic diagram of an analysis system according to an example of the present invention.

FIG. 2 is a view illustrating a connection portion according to the example.

FIG. 3 is a view illustrating a joint according to the example, which is used in the connection portion.

FIG. 4 is a view illustrating the connection portion according to an example.

FIG. 5a is a view illustrating the connection portion according to an example.

FIG. 5b is a view illustrating the connection portion according to an example.

FIG. 6 is a view illustrating a joint according to an example, which is used in the connection portion.

FIG. 7 is a view illustrating a holder according to an example.

FIG. 8 is a view illustrating the connection portion according to an example.

FIG. 9 is a view illustrating the connection portion according to an example.

FIG. 10 is a view illustrating a joint according to the example, which is used in the connection portion.

FIG. 11 is a view illustrating the connection portion according to an example.

FIG. 12 is a view illustrating a joint according to the example, which is used in the connection portion.

FIG. 13 is a view illustrating the connection portion according to an example.

FIG. 14 is a view illustrating the connection portion according to an example.

FIG. 15 is a view illustrating a connection portion according to an example.

FIG. 16 is a view illustrating a connection portion according to an example.

FIG. 17 is a view illustrating a connection portion according to an example.

FIG. 18 is a view illustrating a connection portion according to an example.

FIG. 19 is a view illustrating a connection portion according to an example.

FIG. 20 is a view illustrating a connection portion according to an example.

FIG. 21 is a view illustrating an analysis system according to an example.

FIG. 22 is a view illustrating a microfluidic device according to the example.

FIG. 23 is an example of measurement data obtained by the analysis system of the present invention.

FIG. 24 is an example of measurement data obtained by the analysis system of the present invention.

### DESCRIPTION OF EMBODIMENTS

Hereinafter, the above-mentioned and new characteristics and effects of the present invention will be described with reference to the accompanying drawings. Here, a detailed description of a specific embodiment will be given for the full understanding of the present invention; however, the present invention is not limited to the description herein.

Since the drawings are schematically illustrated for the easy understanding thereof, dimensions and the like may be different from the actual dimensions.

A system of the present invention includes one or more microfluidic devices, one or more pipelines, and one or more analysis apparatuses. The system of the present invention includes one or more connection portions. The “microfluidic device” includes a flow channel, and has at least one of the following functions: formation, holding, and transportation of droplets. The “analysis apparatus” of the present invention serves to analyze the characteristics of droplets, is formed of a structure and software, and is not necessarily an independent apparatus. The “pipeline” of the present invention has a fluid path therein, and droplets are transported from the microfluidic device to the analysis apparatus via the “pipeline”. The “connection portion” of the present invention is a fluidic connection that connects the flow channel of the microfluidic device and the pipeline, and droplets can flow in an orderly row via the connection portion.

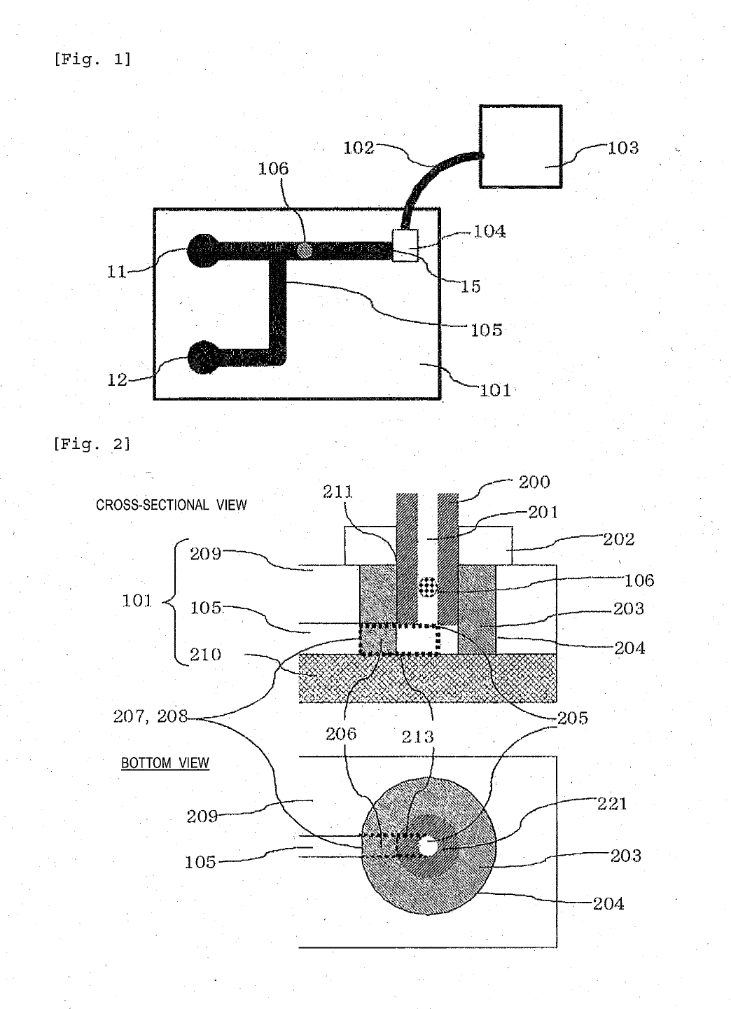

FIG. 1 is a schematic diagram of the analysis system according to the embodiment of the present invention.

The analysis system includes a microfluidic device 101; a pipeline 102; an analysis apparatus 103; and a connection portion 104.

The microfluidic device 101 includes a flow channel 105, and has at least one of the following functions: the formation, the holding, and the transportation of a droplet 106. The analysis apparatus 103 serves to analyze the characteristics of droplets, is formed of a structure and software, and is not necessarily an independent apparatus. The pipeline 102 has a fluid path therein, and the droplet 106 is transported from the microfluidic device 101 to the analysis apparatus 103 via the pipeline 102. The connection portion 104 is a fluidic connection that connects the flow channel 105 of the microfluidic device 101 and the pipeline 102, and droplets 106 can flow in an orderly row via the connection portion 104. Hereinafter, each portion will be described in detail.

[Manufacturing of Microfluidic Device 101]

The microfluidic device 101 is preferably one referred to as a so-called microfluidic device, a microfluidic chip, a microchip, or a micro electro mechanical system (MEMS) device, and typically, the microfluidic device 101 has the shape of a flat plate-like chip. In this case, the microfluidic device 101 has a thickness-in a range of approximately 1 μm to approximately 50 mm, and a lateral side (a thickness, a depth, a diameter) in a range of approximately 10 μm to approximately 500 mm.

The microfluidic device 101 includes a flow channel, for example, a micro flow channel. The micro flow channel is a flow channel, and a part of the dimensions of the flow channel (the dimensions of the cross section of the flow channel, for example, the width or the diameter of the flow channel) is at least 1 mm or less, and preferably, 500 μm or less, 300 μm or less, 100 μm or less, 10 μm or less, or 1 μm or less.

The microfluidic device 101 includes an inlet and a discharge port for the injection or the discharge, or the injection and the discharge of a fluid handled in the device. For convenience, the ports are distinctively referred to as the inlet and the discharge port based on the main, usage of each port; however, typically, it is possible to discharge a fluid via the inlet, and to inject a fluid via the discharge port. The inlet and the discharge port are openings, each of which is provided at the extremity or in the middle of the flow channel, and is opened to the outside of the microfluidic device.

It is possible to manufacture the microfluidic device 101 using a method of manufacturing a so-called microfluidic device, a microfluidic chip, a microchip, or a micro electro mechanical system (MEMS) device. For example, at least apart of the configuration elements of the microfluidic device 101 can be made of a solid material, and in this case, it is possible to form a flow channel, using a lithography technique such as photolithography or electronic beam lithography; an imprint technique such as nanoimprint; a deposition technique such as spin coating, chemical vapor deposition, physical vapor deposition, or sputtering; various wet etching techniques using hydrofluoric acid, potassium hydroxide, or the like; various dry etching techniques such as reactive ion etching or a Bosch process; physical etching such as ion milling; a deposition or processing (removing) technique using laser ablation; a mechanical processing technique such as micro-milling, cutting, grinding; a forming technique such as injection forming or casting; various powder blasting techniques; rapid prototyping; 3D printing; or the like.

The configuration elements of the microfluidic device 101 can be formed of various materials such as semiconductor (for example, silicon), glass, metal, or a polymer material (for example, a natural polymer, material such as paper, thermoplastic resin, thermosetting resin, elastomer, and more specifically, silicone resin, various Teflons (trademark), acryl, polycarbonate, or polystyrene). In addition, the configuration elements of the microfluidic device may be formed of different materials, and each of the structural elements of the flow channel 105, for example, each of the structural elements equivalent to the wall, the bottom, and the ceiling of the flow channel 105 may be formed of a plurality of materials.

It is possible to form a great part or a part of the flow channel 105 as a groove-shaped structure on the surface of a solid member that is a configuration element of the microfluidic device 101. For example, when the microfluidic device 101 is formed by bonding the respective surfaces of two or more solid members, it is possible to form the enclosed flow channel 105 in each of the members by pre-forming a groove in a bonding surface between one or more of the members.

It is possible to dispose a great part or a part of the flow channel 105 in a plane parallel with a largest surface of the microfluidic device 101. At this time, the microfluidic device 101 is formed of flat plate-like members, for example, a silicon wafer and a glass wafer. It is possible to form the flow channel 105 as a groove in one or a plurality of surfaces of the wafers. At this time, since the groove, which is a target for processing, is disposed in a plane, it is possible to easily use a well-known technique such as etching, deposition, or lithography, and it is possible to enjoy many advantages in the aspects of reliability, costs, the types of an applicable technique, and the like. For example, the flow channel is preferably formed of a groove having a depth of 100 μm and a width of 100 μm in the surface of a silicon wafer using deep reactive ion etching. After cleaning the silicon wafer and the glass wafer via a well-known cleaning method, it is possible to bond together the silicon wafer and the glass wafer using anodic bonding, with a grooved surface as a bonding surface. The silicon-glass bonded wafer obtained by the bonding is cut using a well-known proper dicing method, and thereby it is possible to obtain the microfluidic device 101 having the flow channel 105 therein. Before the silicon wafer and the glass wafer are bonded together, it is possible to form the inlet or the discharge port in the silicon wafer, the glass wafer, or both of the silicon wafer and the glass wafer, in which the inlet or the discharge port is formed as an opening such as a through-hole connected to the flow channel. The inlet and the discharge port may be formed after the bonding or the dicing is completed. The through-hole may be formed using various etching techniques, power blasting, or a processing method such as cutting.

The inner surface of the flow channel 105 may be coated or clad with a different material. The coating material or the cladding material or used may affect physico-chemical characteristics (the wettability, the affinity, or the water repellent properties of various liquid), chemical characteristics (reactivity, non-reactivity, passivation, or catalytic activity), mechanical characteristics (strength, elasticity, wear resistance, or the like), and optical characteristics (optical matching with surrounding members, transparency or scattering intensity affected by surface roughness or the like, or various wavelength characteristics).

Specifically, the pipeline 102 of the analysis system may be a capillary, a tube, a pipe, a union, an adaptor, a fitting, or the like, and the material of the pipeline 102 may be various solid materials, and preferably, fused quartz, silicone resin containing polydimethylsiloxane (PDMS), fluorocarbon resin containing various Teflon (a trademark), another resin containing polyetheretherketone (PEEK), polycarbonate (PC), and polystyrene (PS), or metal containing stainless steel.

The surface (an inner surface) (the surface being in contact with the inner space of the pipeline 102) and the outer surface of the pipeline 102 maybe coated or clad with different materials. The coating material or the cladding material used may affect physico-chemical characteristics (the wettability, the affinity, or the water repellent properties of various liquid), chemical characteristics (reactivity, non-reactivity, passivation, catalytic activity), mechanical characteristics (strength, elasticity, wear resistance, or the like), and optical characteristics (optical matching with surrounding members, transparency or scattering intensity affected by surface roughness or the like, or various wavelength characteristics).

The cross-sectional dimensions of the inner space of the pipeline 102, inner diameter, for example, is in a range of approximately 0.1 μm to 1 mm, and preferably, 500 μm or less, 300 μm or less, 100 μm or less, or 50 μm or less.

For example, it is possible to use a capillary made of fused quartz (a capillary having an outer diameter of approximately 360 μm, and an inner diameter of approximately 50 μm to approximately 100 μm) as the pipeline 102. Some advantages for using the fused quartz are that the fused quartz is chemically stable, and has sufficient physical strength for handling, and thereby it is possible to apply various surface modifications to the pipeline 102 using a chlorosilane agent or the like. For example, the pipeline 102 is a capillary made of fused quartz, and the inner surface of the pipeline 102 may be coated with a film made of 1H,1H,2H,2H-Perfluorooctyl-trichlorosilane. Accordingly, the inner surface has water repellent properties for an aqueous solution, and it is possible to reduce the non-specific adsorption of various objects, particularly, objects having hydrophilicity or hydrophobic properties (solvent affinity) to the inner surface. In addition, similarly, the outer surface may be coated with a polyimide film, and thereby, the mechanical strength increases, and it is possible to easily handle the pipeline 102.

[Outline of Connection Portion]

In this specification, a fluid path is a path for the flow of a fluid, and is a space for the holding or the transportation of a fluid, or the holding and transportation of a fluid. The examples of the fluid path include an inner space of a hollow pipe, a flow channel of a so-called microfluidic device, or the like. A member with a fluid path alone may form the fluid path, or a member with a fluid path may form the fluid path along with another member. For example, a flat plate-like member having a grooved surface and another flat plate-like member having a smooth surface are assembled together by pressing the member against the other member or bonding the members together, and thereby it is possible to allow a fluid (for example, water) to flow or hold the fluid in a space interposed between the groove and the smooth surface. At this time, the above-mentioned space is referred to as a fluid path, and the groove (the groove not being assembled yet) is also referred to as a fluid path since the groove is an element that determines the position of a path for the flow of a fluid when being assembled. The fluid path may have a confluence or branches.

In the specification, the fluidic connection implies that when two or more structures having fluid paths (for example, flow channels or pipelines) are in contact with each other, and the fluid paths of the structures are in contact with each other, in a state where the fluid can pass between the structures in one direction or multiple directions, the structures are in close contact with each other to the extent that the fluid does not leak from the structures. At this time, it can be considered that these fluid paths form one large fluid path.

In the specification, the expression “droplets flow in an orderly row” implies that the droplets flow along a fluid path along with a fluid that flows around the droplets, while the droplets or a part of the droplets are not fused together or are not split. In addition, at this time, the expression implies that the orderly row of the droplets (the row being intended by the design of the system or a manipulation of a user) is not disturbed, that is, the order of the droplets is not changed, and the droplets flow at a pre-intended timing.

### EXAMPLE 1 OF CONNECTION PORTION 104

The embodiment provides the connection portion 104 that realizes a fluidic connection through which the droplets 106 can flow in an orderly row. FIG. 2 illustrates the connection portion 104 of the analysis system. Here, the connection portion 104 realizes the fluidic connection between a fluid path 201 of a capillary 200 (the pipeline 102) made of fused quartz and the flow channel 105 of the microfluidic device 101.

The structure of microfluidic device 101 is formed by bonding a silicon layer 209 and a glass layer 210, and the flow channel 105 and a connection hole 204 are formed in the silicon layer 209 using reactive ion etching. A joint 203 is inserted into the hole 204, and the capillary 200 is inserted into an opening 211 (the opening being close to the pipeline) of the joint 203. The capillary 200 is held by a holding ferrule 202 made of fluorocarbon rubber, and is fixed in order for a capillary opening 205 to be disposed at a proper position. The joint 203 has a shape illustrated in FIG. 3, and a groove (a fluid path) 206 is provided in a portion of the joint 203 close to the flow channel 105. The groove 206 and the joint 203 are in close contact with the glass layer 210 of the microfluidic device 101 due to the holding ferrule 203. Accordingly, a space made by the groove 206 and the glass layer 210 acts as a fluid path, and the extremity of the groove 206 acts as an opening (the opening being close to the flow channel) 208. The position of the opening 208 of the joint 203 is aligned the position of an opening 207 at the extremity of the flow channel in such a manner to face each other, and the opening for a flow channel 208 is fixed while being pressed against the glass layer 210 of the microfluidic device 101 by the holding ferrule 202. The joint 203 is made of a material such as PDMS having elasticity, and since the joint 203 is in liquid-tightly close contact with the glass layer 210, the wall of the hole 204 of the silicon layer 209, and the outer surface of the capillary 200, a fluid that flows through the flow channel 105 does not leak therefrom. Accordingly, fluidic connection between a fluid path 201 of the capillary and the flow channel 105 is realized. Fluoric oil flows through the flow channel 105, and the droplets 106 in the oil flow toward the connection portion 104. The droplets 106 flow into the fluid path 201 of the capillary via the flow channel opening 207, the opening (the opening being close to the flow channel) 208 of the joint 203, a fluid path of the joint 203, the opening (the opening being close to the pipeline) 211 of the joint 203, and then the capillary opening 205.

At this time, most preferably, when the respective cross-sectional sizes of the flow channel 105 and the capillary opening 205 are substantially the same, and are substantially the same as that of the fluid path of the joint 203, a single continuous fluid path is actually formed, and a fluid actually flows in the form of a laminar flow as in the flow channel 105 or the pipeline 102. For this reason, the droplets 106 that flows in the fluid path can flow in an orderly row. Here, the shortest straight fluid path of the joint 203 is an ideal fluid path. Here, the expression that the cross-sectional sizes are substantially the same implies that any one of a cross-sectional area and a length in a direction in which a cross-sectional diameter becomes the minimum is substantially the same between paths. More preferably, both of the cross-sectional area and the length in a direction in which the cross-sectional diameter becomes the minimum are substantially the same between the paths.

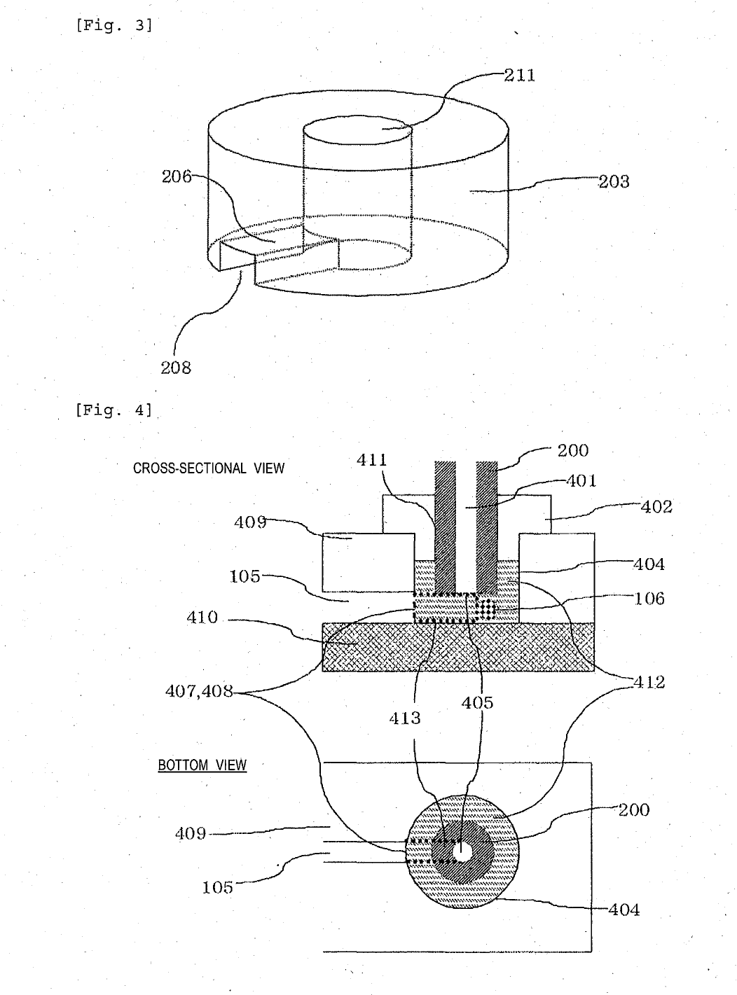

In contrast, for example, as illustrated in FIG. 4, when the capillary 200 inserted into a connection hole 404 is fixed with only a holding ferrule 402, a large dead volume 412 in a fluid path is formed in the connection hole 404 in addition to an ideal fluid path 413. Due to the additional dead volume 412, concavities and convexities are formed in the shape of the fluid path, or the stagnation of a flow occurs. For this reason, occasionally, the droplets 106 stagnate while being trapped in the concavities and convexities, or flowing into the dead volume 412. Then, the stagnant droplets maybe fused with other droplets that flow subsequently. The remainder of the droplets 106 flows into the capillary 200 while a part of the droplets 106 is stagnant, and thereby the droplets 106 may be split.

It is possible to considerably reduce the dead volume 412 added to an ideal fluid path 213 using the joint 203 previously illustrated in FIG. 2. For this reason, the connection portion 104 illustrated, here allows the droplets 106 to flow in a remarkably orderly row.

The connection portion 104 of the analysis, system preferably includes the opening (the opening being able to, realize fluidic connection) 207 of the flow channel 105 of the microfluidic device 101; the opening (the opening being able to realize fluidic connection) 205 of the pipeline 102; and the joint 203 including the fluid path with at least two openings (the openings being able to realize fluidic connection) 208 and 211. The flow channel opening 207 is fluidic connected with one of the openings of the joint, and the pipeline opening 205 is fluidic connected with the other of the openings 208 and 211 of the joint. Accordingly, it is possible to provide fluidic connection that allows the droplets 106 to flow in an orderly row.

The joint 203 used in the connection portion 104 has a plurality of the openings. In one example of the joint, a surface having one opening is not preferably parallel with at least another surface having an opening. Accordingly, even when the direction of the flow channel 105 of the microfluidic device 101 is different from that of the pipeline 102, it is possible to realize a desired fluidic connection. Here, the “surface” refers to one continuous surface, and may be a flat surface or a curved surface. Accordingly, the expression that a portion is parallel with a surface having an opening implies that the portion is actually parallel with a flat surface in contact with an opening portion.

More preferably, the two openings 208 and 211 of the joint 203 are substantially orthogonal to each other. At this time, it is easy to manufacture the connection portion 104 using a typical method of manufacturing a microfluidic device. For example, when the flow channel and the connection hole 204 are formed in a flat plate-like substrate (for example, a silicon wafer or a glass wafer) using reactive ion etching, as illustrated in FIG. 2, the hole 204 is formed in such a manner to be orthogonal to the substrate and the flow channel.

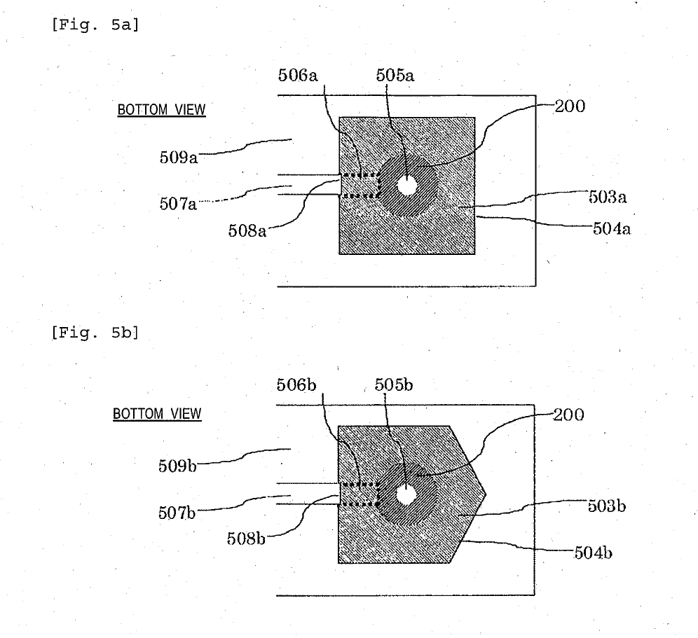

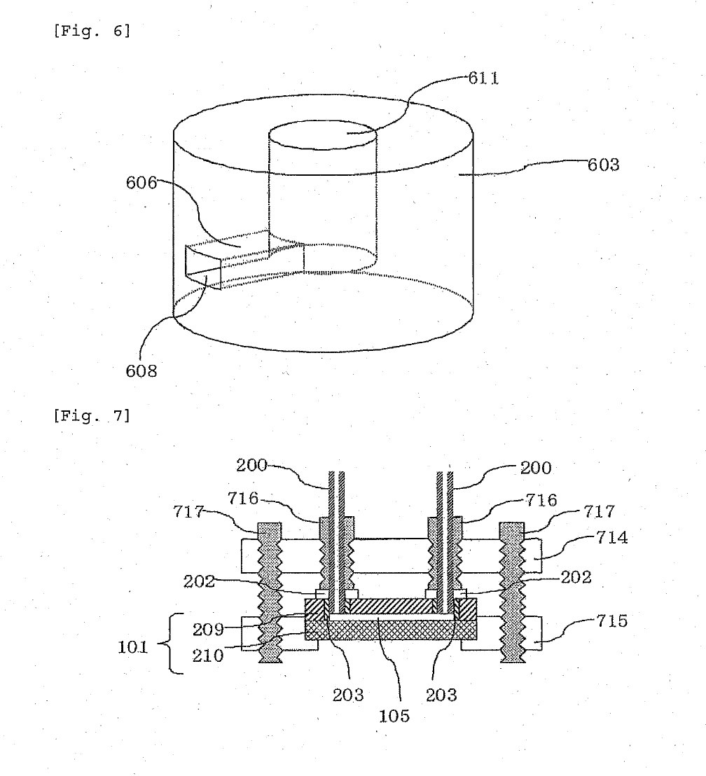

At this time, the connection hole 204 may have a circular cylindrical shape as illustrated in FIG. 2, or may have an angled shape such as a polygonal shape as illustrated in FIG. 5a. At this time, since a joint 503a does not rotate freely as the circular joint, it is easy to align the orientation of an opening of the joint 503a with an opening of a flow channel 507a. In addition, a joint may have a non-symmetrical polygonal shape as illustrated in FIG. 5b. At this time, since a joint 503b is fitted into a connection hole 504b in only a single way, the joint 503b and the connection hole 504b more easily face other. In this case, the connection holes 504a and 504b may have shapes corresponding to the joints 503a and 503b, respectively.

In addition, a non-straight fluid path is formed in the structure of the joint used in the connection portion 104. More preferably, the fluid path of the joint is substantially vertically bent once in the middle of the fluid path. Accordingly, even when the direction of the flow channel 105 of the microfluidic device 101 is different from that of the pipeline 102, it is possible to realize a desired fluidic connection. FIGS. 2 and 3 illustrate the examples of each of the joint and the connection portion 104.

In FIG. 2, when at least a part of the fluid path of the joint 203 is in contact with another structural body (here, the glass layer 210 being positioned on the bottom surface of the connection hole 204 of the microfluidic device 101), the function of the fluid path is realized; however, in another preferred example, as illustrated in FIG. 6, a fluid path of a joint 603 may be formed of only the structure of the joint 603. At this time, the shape of the connection hole 204 is preferably formed in such a manner to correspond to the joint 603. For example, a structure can be formed in such a manner that the position of an opening (an opening being in contact with the microfluidic device 101) 608 of the joint 603 can be aligned with the position of an opening 207 of a flow channel of the microfluidic device 101, when the bottom surface of the hole 204 is dug into the glass layer 210.

In a preferred example, a fluidic connection between the opening 208 of the joint and the opening 207 of the microfluidic device 101 is easily and reversibly attachable and detachable. The examples of the above-mentioned fluidic connection include the following cases: the case in which liquid-tight contact between surfaces, at least one of which has proper elasticity, is realized by the self-adsorption of the surfaces or by pressing the surfaces against each other; and the case in which liquid-tight contact between sufficiently smooth surfaces, each of which has a complimentary fitting shape or a flat shape, is realized by the self-adsorption of the surfaces or by pressing the surfaces against each other. The pressing of one surface against the other surface may be realized using screws, a spring, fluidic pressure (for example, oil pressure or air pressure), or the like. The advantage of such an attachable and detachable connection portion is that the system is easily installed, assembled, used and maintained.

In a preferred example, fluidic connection between the opening 208 of the joint and the opening 207 of the microfluidic device 101 is realized by pressing the joint and the microfluidic device 101 against each other without using an adhesive but screws, a spring, or the like. There is an advantage in that since an adhesive is not used, a fluid that flows through the fluid path is not in contact with the adhesive, and an adhesive component does not dissolve into the fluid.

For example, a holder illustrated in FIG. 7 can provide pressing required for realizing such an attachable and detachable fluidic connection. The holder is formed of holder upper portion 714 and a holder lower portion 715, and the holder upper portion 714 and the holder lower portion 715 are fastened together using screws 717 while being interposed between the screws 717. At this time, since a nut 716 screwed into a screw hole of the holder upper portion 714 is also interposed along with the holder upper portion 714 at the same time, the nut 716 presses the holding ferrule 202 downward. The holding ferrule 202 is pressed downward against the silicon layer 209 of the microfluidic device 101 using the nut 716, is deformed, is brought into close contact with the capillary 200, the joint 203, and the like, and then is fixed. In fixing means illustrated in FIG. 7, the entirety of the joint 203, the holding ferrule 202, the capillary 200, the nut 716, the screw 717, the holder upper portion 714, and the holder lower portion 715 are pressed against each other using screw clamping, are easily attachable and detachable, and can be reused.

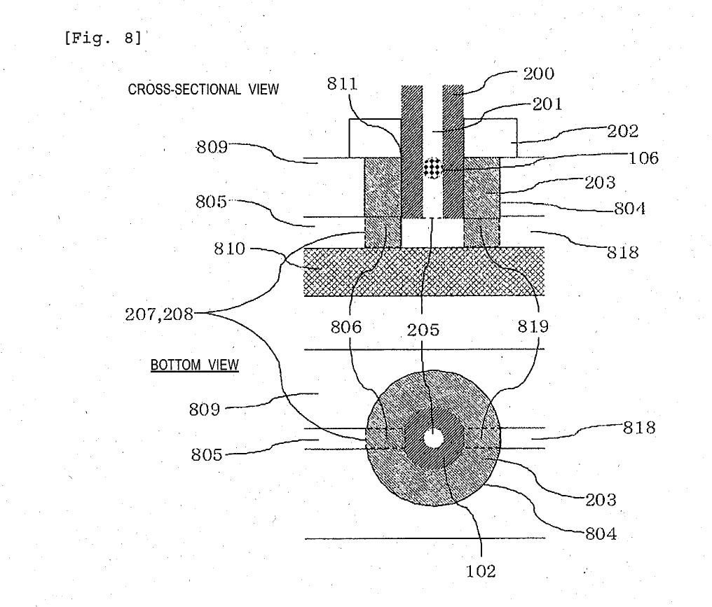

Preferably, it is possible to provide the opening (the opening being able to realize fluidic connection) at the extremity or in the middle of the flow channel of the microfluidic device 101. Preferably, it is possible to provide the opening (the opening being able to realize fluidic connection) atone extremity of the pipeline 102. For example, as illustrated in FIG. 8, it is possible to provide the connection portion 104 in the middle of a flow channel that continues from a flow channel 805 to a flow channel 818. At this time, a fluid may flow through both of the flow channel 805 and the flow channel 818, and may be discharged to the capillary 200. A part of a fluid may flow through the flow channel 805, and may be discharged to the capillary 200, and the remainder may flow through the flow channel 818. In addition, an adjusting mechanism (for example, a valve) may be provided in the middle of each of the capillary 200 and the flow channels 805 and 818, and an operational state of any one of the capillary 200, and the flow channels 805 and 818 may be switched each time. From the description up to this point, it is apparent that the connection portion 104 illustrated in FIG. 8 has such a function. In this structure, a confluence is provided in the flow channel 105 through which the droplets 106 flow, and thereby it is possible to increase throughput or to concurrently perform processes under a plurality of conditions by parallelizing processes via a plurality of the flow channels 805 and 818. In addition, in this structure, the droplets 106 are discharged through the branched flow channels, and thereby it is possible to transport only the specific droplets 106 to the analysis apparatus 103 on an upstream side of the pipeline, or to distribute a plurality of the droplets under the same conditions to a plurality'of different analysis apparatuses.

FIG. 9 illustrates another preferred example of the structure of a joint. The structure of the joint is basically the same as that illustrated in FIG. 2; however, in this example, in FIG. 2, an additional dead volume present below the opening of the capillary 200 is filled with a material in the structure of a joint 903, a distal end 221 of the capillary is held by a stepped portion 922 in a part of the joint while being pressed against the stepped portion 922, and the fluidic connection is realized. Accordingly, a fluid path of the joint 903 has almost no dead-volume, and since a fluid path substantially the same as the ideal fluid path illustrated in FIG. 2 is realized, the droplets 106 more reliably flow in an orderly row.

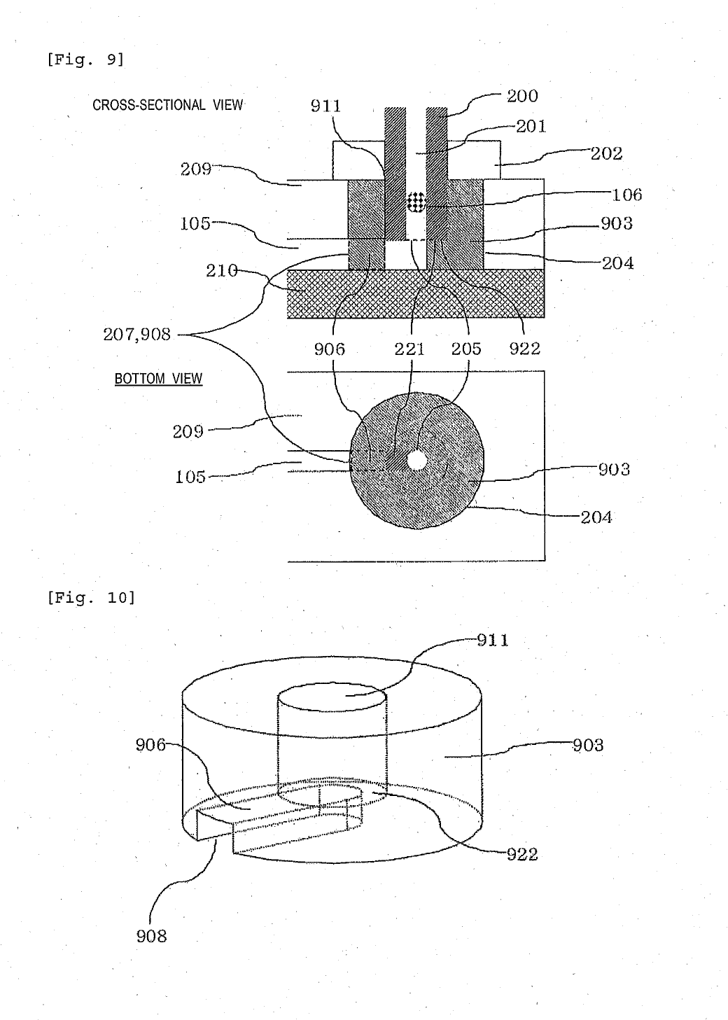

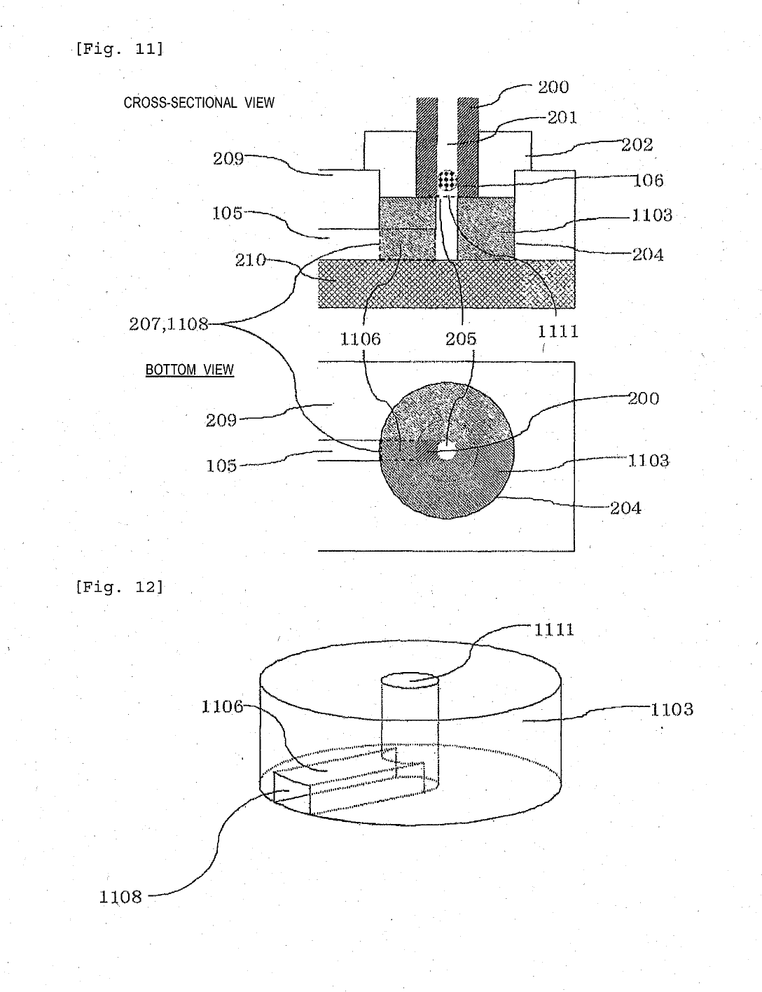

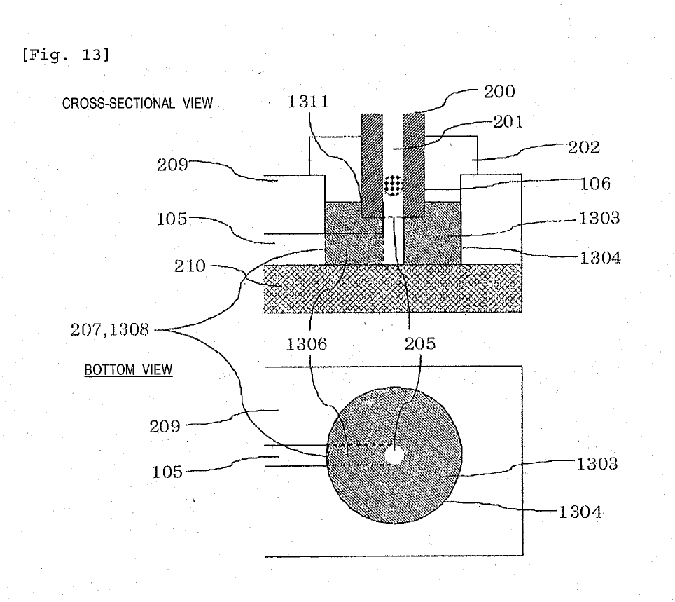

In addition, in the connection portion 104, two structures, each of which includes a fluid path having an opening, maybe fluidic connected to each other in the following patterns. (1) At least a part of a surface having an opening in its structure is in liquid-tight contact with at least a part of another surface having an opening in its structure. (2) At least a part of a surface having an opening in its structure, and at least a part of one or a plurality of stacked surfaces surrounding the surface are in liquid-tight contact with at least a part of another surface having an opening in its structure. The fluidic connection can be realized using any one of the above-mentioned patterns. In addition, in one connection portion, the patterns (1) and (2) are mixed together. For example, in the structure illustrated in FIGS. 9 and 10, the fluidic connection between the flow channel 105 of the microfluidic device 101 and the joint 903 is realized using the pattern (1), and the fluidic connection between the joint 903 and the capillary 200 is realized using the pattern (2). In the connection portion 104 illustrated in FIG. 11, both of the fluidic connection between a flow channel of the microfluidic device 101 and a joint, and the fluidic connection between the joint and the capillary are realized using the pattern (1). A joint 1103 illustrated in FIG. 11 has a structure illustrated in FIG. 12, and the structure is substantially the same as that of the joint 203 illustrated in FIG. 3. In FIG. 3, the opening 1111 close to the pipeline has a diameter corresponding to the outer diameter of the pipeline 102; however, in the example illustrated in FIG. 12, an opening 1111 close to the pipeline is made to have a diameter corresponding to the inner diameter of the pipeline 102 or the diameter of the pipeline opening 205.

Referring to one of advantages of each pattern, since the two surfaces (each of which has an opening) are simply in liquid-tight contact with each other, the structure of the pattern (1) is likely to become simple. In the connection portion 104 illustrated in FIGS. 9 and 11, the fluid path having substantially the same shape is formed; however, when the structure of the joint 903 of the connection portion 104 is compared with the structure of the joint 1103 of the connection portions 104, the joint 1103 in FIG. 12 has a structure simpler than that of the joint 903 in FIG. 10. In contrast, the pattern (2) has an advantage in that it is possible to easily determine the positions in order for the openings face each other. In FIG. 11, the position of the capillary 200 is required to be accurately aligned in order for the opening 205 of the capillary to be aligned with the opening 1111 of the joint, and for example, it is necessary to align the position of the capillary 200 while observing the capillary 200 through the transparent glass layer 210 of the microfluidic device 101 using a microscope or the like, or it is necessary to use the holding ferrule 202 made of a material having a relatively high rigidity while increasing the size of the connection hole 204 and the accuracy of the dimension of the holding ferrule 202. However, in FIG. 9, since the capillary is held while a distal end portion 921 of the capillary is inserted into an opening 911 of the joint 903, the alignment of a position is relatively easy.

In another example of a joint illustrated in FIG. 13, the fluidic connection between the flow channel 105 of the microfluidic device 101 and the joint is realized in the pattern (1), and the fluidic connection between the joint and the capillary 200 is realized in the pattern (2). Similar to the connection portion 104 in FIG. 9, since a fluid path having almost no dead volume is realized, the droplets 106 more reliably flow in an orderly row. At the same time, there is an advantage in that it is possible to easily determine the positions in order for a joint 1303 and the opening 205 of the capillary 200 to face each other.

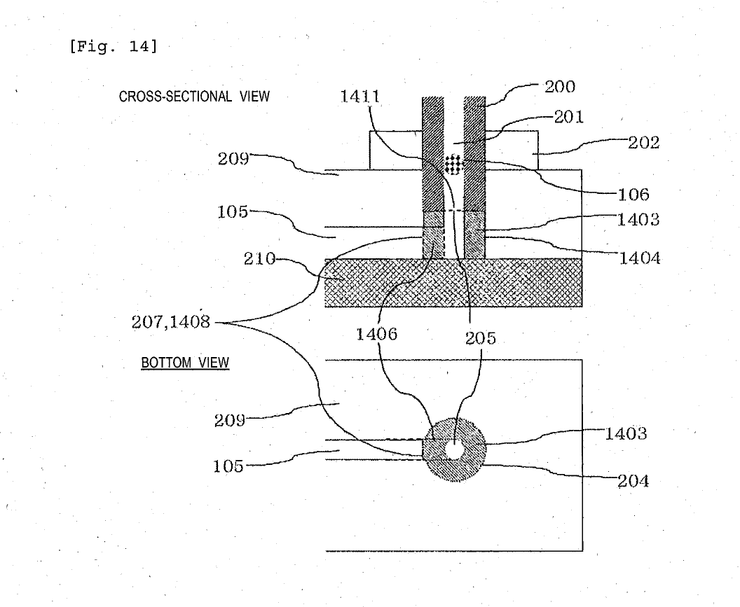

In another example of the connection portion 104 illustrated in FIG. 14, both of the fluidic connection between the flow channel 105 of the microfluidic device 101 and a joint, and the fluidic connection between the joint and the capillary 200 are realized in the pattern (1). In many parts, the connection portion 104 is the same as the connection portion 104 in FIG. 11; however, here, a connection hole 1404 is made so as to correspond to the outer diameter of the capillary 200, and a joint 1403 is made so as to have a size corresponding to the outer diameter of the capillary 200. Since the outer surface of the capillary 200 is contact with the wall surface of the hole 1404, the position of the capillary 200 is guided by the wall surface of the hole 1404. Accordingly, it is possible to easily to align the respective positions of the opening 205 of the capillary 200 and an opening 1411 of the joint 1403. Similar to the example illustrated in FIG. 11, since a fluid path having almost no dead volume is realized, the droplets 106 more reliably flow in an orderly row.

Preferably, two openings, which are connected to each other in a fluidic connection state according to the above-mentioned pattern, have substantially the same cross-sectional area. For example, in one connection of the fluid paths illustrated in FIG. 2, the flow channel opening 207 of the microfluidic device 101 and the opening 208 of the joint have substantially the same cross-sectional area. When a fluid, particularly, water (a fluid not being nearly compressed) flows through a fluid path without a leakage or a flow branch, a flow rate is constant at each point in the fluid path. Typically, a flow velocity at each point is inversely proportional to the cross-sectional area of the fluid path. Accordingly, when the cross-sectional area is constant, the flow velocity is constant. When the flow velocity decreases, as described above, the droplets 106 may potentially stagnate. When the flow velocity increases excessively, Reynolds number increases, a turbulent flow is likely to occur, shearing stress increases, thereby causing the droplets 106 to be split. That is, when the flow velocity is stable, or a change in cross-sectional area decreases, the droplets 106 more, reliably flow in an orderly row. A Reynolds number Re is a dimensionless number defined by

Re=ρVL/μ

Here, ρ [kg/m³] is the density of the fluid, μ [N·s/m²] is the coefficient of viscosity of the fluid, V [m/s] is the representative velocity of the fluid, and L [m] is the representative length of the fluid path. The value of each of the representative velocity and the representative length is selected so as to characterize the system, and for example, an average flow velocity is selected as the representative velocity, and the minimum value (the thickness of a flow channel when the flow channel is flat) of the cross-sectional diameter of the fluid path is selected as the representative length. When the Reynolds number increases, a turbulent flow is likely to occur, and when the Reynolds number decreases, a laminar flow is likely to occur.

The material of the joint may be various solid materials, and preferably, fused quartz, silicone resin containing polydimethylsiloxane (PDMS), fluorocarbon resin containing various Teflon (a trademark), another resin containing polyetheretherketone (PEEK), polycarbonate (PC), and polystyrene (PS), or metal containing stainless steel. More preferably, it is possible to use a material having proper elasticity and proper rigidity convenient for forming a surface in liquid-tight contact with other structures. It is possible to use various resin materials as such a material. The surface (an inner surface) (the surface being in contact with the inner space of the joint) and the outer surface of the joint may be coated or clad with different materials. The coating material or the cladding material used may affect physico-chemical characteristics (the wettability, the affinity, or the water repellent properties of various liquid), chemical characteristics (reactivity, non-reactivity, passivation, catalytic activity), and mechanical characteristics (strength, elasticity, wear resistance, or the like). In particular, it is possible to assist in the flow of the droplets 106 in an orderly row without disturbing the flow of the droplets 106 by matching the wettability of the fluid used and the wettability of the wall surface of the fluid path of the flow channel 105 or the pipeline 102.

Such a joint may be made using various well-known processing methods. For example, the joint 203 illustrated in FIG. 3 can be formed of PDMS using a soft lithography method. Specifically, the silicon wafer is spin-coated with a first layer made of negative photoresist SU-8, is exposed to light while being masked with a pattern corresponding to the groove 206 which is the fluid path of the joint 203, and is cured. Subsequently, the resultant silicon wafer is coated with a second layer made of SU-8, and is exposed to light while being masked with a donut-like pattern, thereby forming the structure that specifies the opening 211 close to the pipeline and the outer circumference of the joint 203. The joint 203 illustrated in FIG. 3 is obtained by using a developed SU-8 member as a mold, flowing PDMS into the mold, curing the member, peeling the PDMS, and then cutting down the remainder of the PDMS. It is possible to control the thickness of the groove (the fluid path) 206 of the joint 203 via the thickness of the first layer, and it is possible to control the thickness of the entirety of the joint 203 via the sum of the first layer and the second layer, and via a final cutting process. It is possible to control the outer diameter of the joint 203, the size of the opening 211 of the joint, and the width of the groove (the fluid path) 206 using a photo-mask pattern and lithography. In addition, it is possible to manufacture the joint using various processing methods such as injection forming, cutting, and 3D printing.

### EXAMPLE 2 OF CONNECTION PORTION

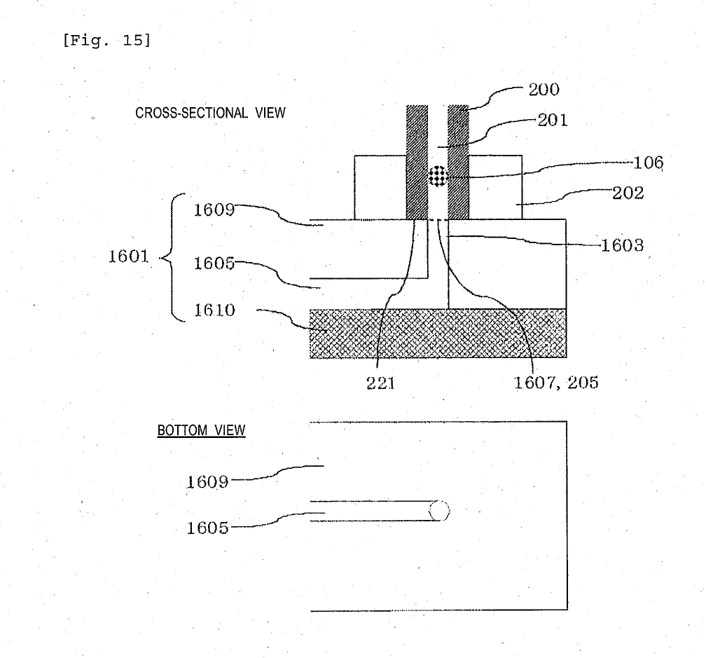

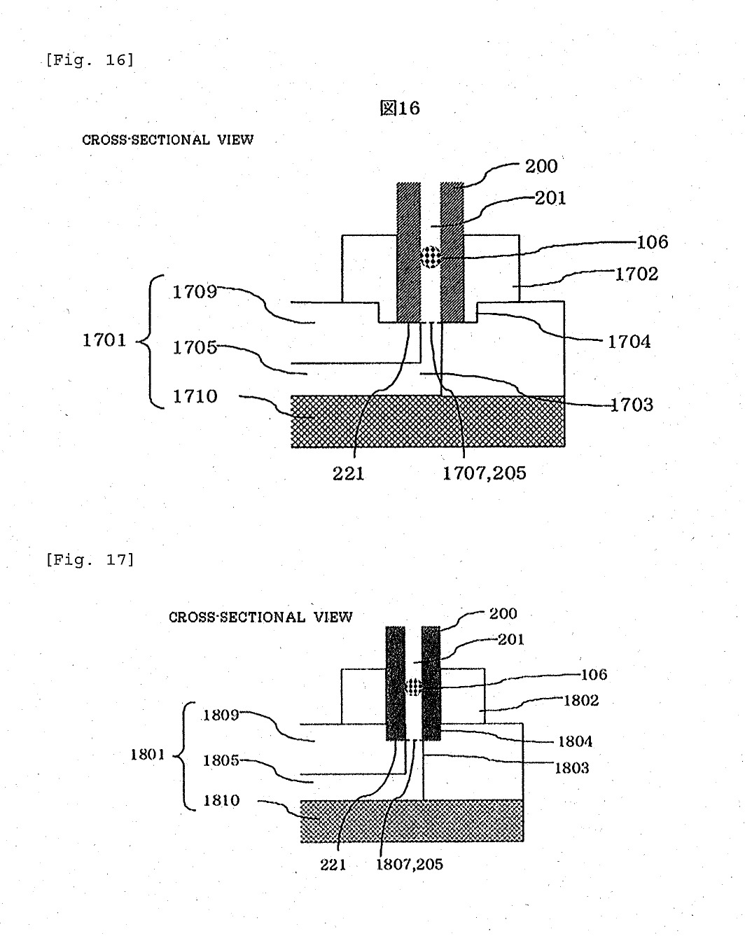

FIG. 15 illustrates an example of the connection portion 104 of the analysis system. Here, the connection portion 104 realizes the fluidic connection between the fluid path 201 of the capillary 200 (the pipeline 102) made of fused quartz and a flow channel 1605 of a microfluidic device 1601. An extremity portion 1603 of the flow channel 1605 is orthogonal to the surface of the microfluidic device 1601, and a flow channel opening 1607 is positioned on the surface of the microfluidic device 1601. A surface in the vicinity of the opening 1607 of the flow channel 1605 and a surface in the vicinity of the opening 205 of the capillary, that is, an end surface 221 of the capillary is sufficiently smooth, and it is possible to maintain liquid-tight contact, and the fluidic connection between the capillary and the joint by bringing the openings 1607 and 205 into contact while the openings 1607 and 205 fade each other, and fixing the openings 1607 and 205 with the holding ferrule 202 or the like. It is possible to realize the smoothness of the surface in the vicinity of the flow channel opening 1607 using a typical well-known technique such as a combination of a silicon wafer and etching, and it is possible to realize the smoothness of the end surface 205 of the capillary using a well-known technique. It is possible to fix the structure illustrated in FIG. 15 using the holder or the like previously illustrated in FIG. 7. Also with this configuration, it is possible to allow the droplets 106 to flow in an orderly row by realizing fluidic connection having almost no dead volume.

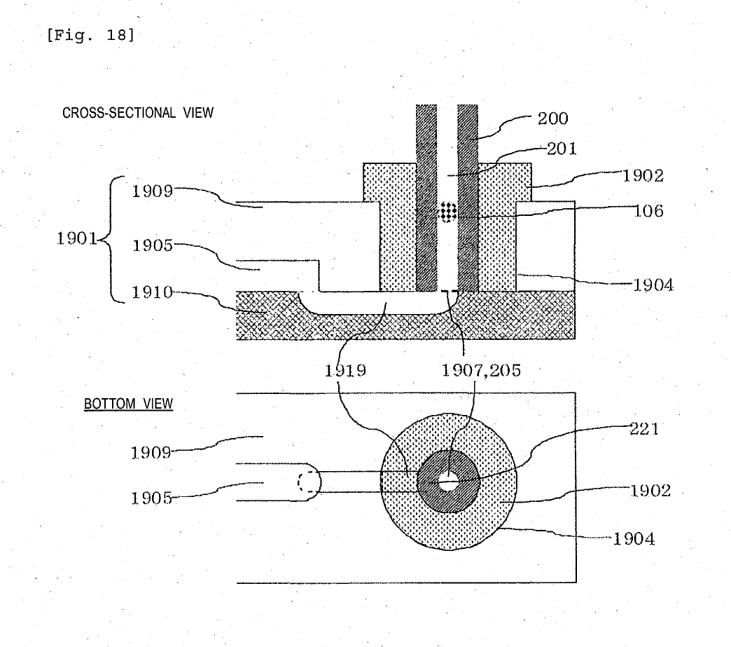

FIGS. 16 and 17 illustrate another preferred example of the connection portion 104. The connection portion 104 has substantially the same configuration as illustrated in FIG. 15; however, microfluidic devices 1701 and 1801 are respectively provided with connection holes 1704 and 1804. In FIG. 16, the capillary 200 is inserted into the hole 1704 along with a holding ferrule 1702. The end surface 221 of the capillary and the bottom surface of the hole are formed in such a manner to be sufficiently smooth, and are brought into contact, and thereby the fluidic connection between the end surface 221 and the bottom surface of the hole is realized. The shape of the holding ferrule 1702 is formed in such a manner that the holding ferrule 1702 is fitted into the hole 1704, and thereby it is easy to align the position of the opening 205 of the capillary with the position of a flow channel opening 1707. Similarly, also in FIG. 17, the connection hole 1804 is formed so as to correspond to the outer diameter of the capillary 200, and the capillary 200 alone is inserted into the hole 1804. Accordingly, it is easy to align the position of the opening 205 of the capillary with the position of a flow channel opening 1807. Also in the connection portion 104 illustrated in FIGS. 16 and 17, it is possible to allow the droplets 106 to flow in an orderly row by, realizing fluidic connection having almost no dead volume.

### EXAMPLE 3 OF CONNECTION PORTION

FIG. 18 illustrates another preferred example of the connection portion 104 of the analysis system. Here, the connection portion 104 realizes the fluidic connection between the fluid path 201 of the capillary 200 (the pipeline 102) made of fused quartz and a flow channel 1905 of a microfluidic device 1901. A distal end portion of the flow channel 1905 is formed as a groove 1919 in a glass layer 1910, and a flow channel opening 1907 is positioned on the bottom surface of a connection hole 1904. The connection hole 1904 is formed as a through-hole in a silicon layer 1909. It is possible to form such a through-hole using deep reactive ion etching or the like before the glass layer and the silicon layer are bonded together. There is an advantage in that since the connection hole 1904 is a through-hole, it is easy to process the hole 1904 without controlling the depth thereof during the formation. The capillary 200 is inserted into the hole 1904 along with a holding ferrule 1902, is fixed and pressed against the bottom surface of the hole 1904 using the holding ferrule 1902. This pressing brings the holding ferrule 1902 and the capillary 200 into liquid-tight contact with the glass layer 1910 that forms the bottom surface of the hole 1904. When the groove 1919 of the glass layer, the holding ferrule 1902 and the end surface 221 of the capillary are assembled together, the distal end portion of the flow channel 1905 acts as a fluid path. With this configuration, in the connection portion 104, it is possible to allow the droplets 106 to flow in an orderly row by realizing fluidic connection having almost no dead volume.

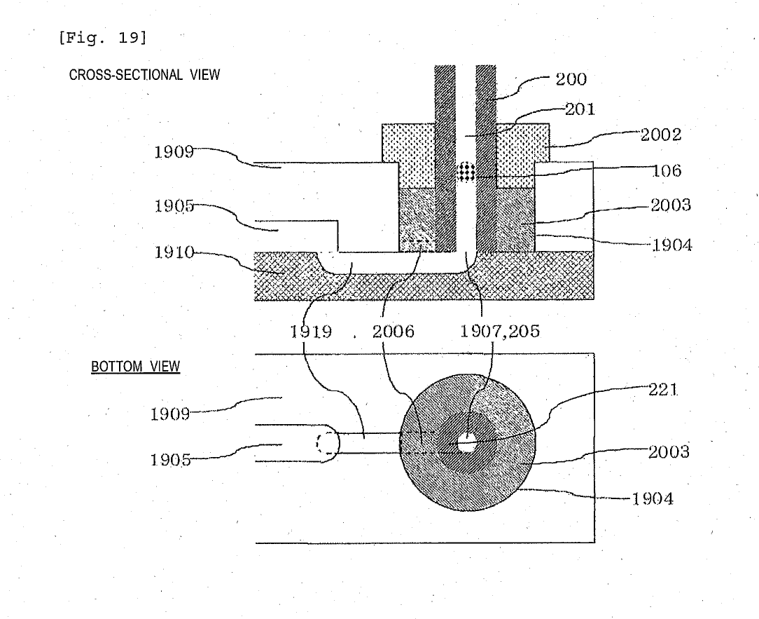

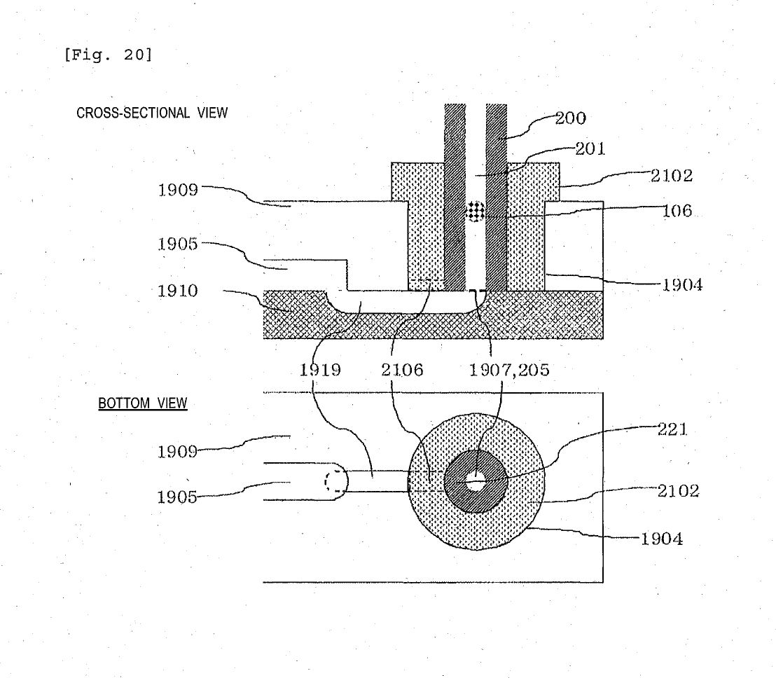

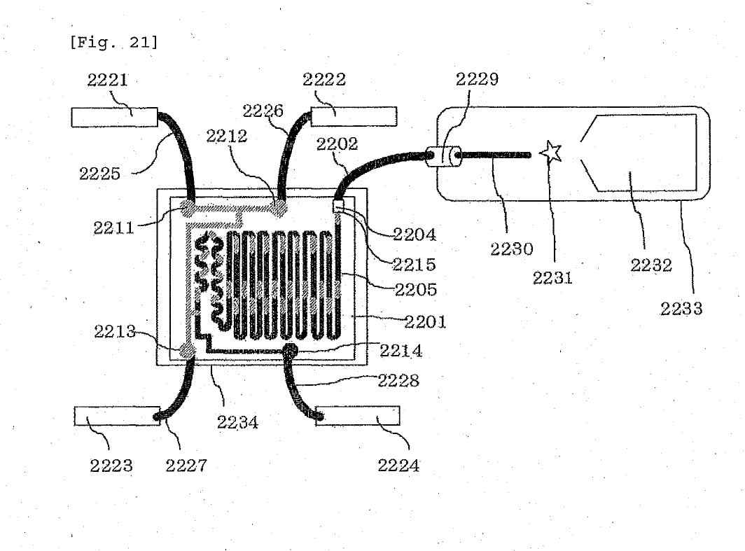

FIGS. 19 and 20 illustrate another preferred example of the connection portion 104. In FIG. 19, the holding ferrule 1902 of the connection portion illustrated in FIG. 18 is replaced with an assembly of a holding ferrule 2002 and a grooved ferrule 2003. Here, a fluid path of the distal end portion of the flow channel 1905 is formed by the assembly of the groove 1919 of the glass layer, the grooved ferrule 2003, and the end surface 221 of the capillary. At this time, a groove 2006 of the grooved ferrule is disposed in such a manner to face the groove 1919 of the glass layer. The groove of the grooved ferrule 2006 can prevent an excessive upward pressing force from causing deformation, and thereby it is possible to prevent the groove 1919 of the glass layer from being interposed between the ferrule and the glass layer. Accordingly, it is easy to adjust an upward pressing force, and it is easy to handle the connection portion. In addition, as illustrated in FIG. 20, it is possible to obtain the same effects as in FIG. 19 even when using a grooved holding ferrule 2102 that is obtained by integrally forming a holding ferrule and a grooved ferrule, and it is much easy to handle the ferrule during the assembly or the attaching and detaching of the ferrule, by integrally forming ferrules 2002 and 2003. Also with the configuration illustrated in FIGS. 19 and 20, in the connection portion 104, it is possible to allow the droplets 106 to flow in an orderly row by realizing fluidic connection having almost no dead volume.

[Details of Function of System]

Hereinafter, the function and operation of the analysis system using the above-mentioned structure will be described in detail.

The analysis system can be used so as to control and execute a target reaction in a solution containing specimens for various analyses of the specimens, and to measure the results of the reaction. For example, the analysis system can be used for a scientific analysis (enzyme reaction kinetics, the measurement of DNA arrangement or the number of DNAs, or the like), a clinical analysis, monitoring for synthesis and production, or the like.

The function of the analysis system is to provide means for (1) forming the micro droplets (reaction droplets) 106 to cause a target reaction in the microfluidic device 101, (2) controlling the reaction in the droplets 106 as reaction containers, (3) extracting the droplets 106 from the microfluidic device 101, and (4) analyzing the results of the target reaction via the measurement of the droplets 106. Hereinafter, each of (1) to (4) will be described in detail.

[(1) Preparation of Reaction Droplet]

The examples of a reaction are a chemical reaction, a physical reaction, or a biological reaction.

It is possible to start a reaction by adding, applying, or mixing reactive elements. The reactive element is a main element to cause a reaction, and for example, the reactive element may be a substance such as an enzyme, a substrate, an antibody, or an antigen, or may be a biological specimen such as a small biont, a cell or a cell group of an animal or a plant, a tissue slice, a bacterium or a fungi, or a virus. The reactive element also includes a secondary element. Here, the secondary elements is a subject that promotes, inhibits, aids, or “start” a reaction, or a subject that prevents an occurrence of devitalization originating from flocculation, coagulation, extraction, degeneration, adsorption, or the like, or that can provide environments for affecting a reaction. The examples of the secondary element are a catalyst, a promoter, an agonist, an inhibitor, an antagonist, a pH buffer, an oxidation-reduction agent, various metal ions or various typical salts, a surfactant, a degeneration inhibitor, various macromolecular prodrugs or various low molecular prodrugs, pharmaceuticals or candidate materials for pharmaceuticals or a precursor, a culture medium, or an induction material. In addition to the above-mentioned substances, the secondary element may be a change in physical quantity or chemical quantity such as temperature, pressure, a velocity, a photoreaction (electromagnetic reaction), a sound wave, an electric field, a magnetic field, or pH. Preferably, the start of a reaction can be controlled by a change of the physical quantity or the chemical quantity which is described above. The start of a reaction may be controlled by contact with a solid phase such as a catalyst. The start of a reaction may be controlled by a combination of these secondary elements, or due to a free combination of the main element and the secondary element.

For example, a PCR reaction using a hot start enzyme (AmpliTaq Gold (a trademark) DNA polymerase) contains an enzyme, a primer DNA, a template DNA, and a buffer (a pH buffer) as the reactive elements; however, the reactive elements are mixed with an enzyme after being mixed without the enzyme, and thereby a reaction may start, or the entirety of the reactive elements containing an enzyme is kept at an proper temperature (for example, for five minutes at a temperature of 95° C.) after being mixed together, and thereby a reaction may start. A proper temperature adjustment method is well known to persons skilled in the art.

It is possible to terminate a reaction via a reaction termination process. The reaction termination process can be activated by changing or removing the reactive element (the main element or the secondary element), or adding a substance. The reaction termination process may be a change in physical quantity or chemical quantity such as temperature, pressure, a velocity, a photoreaction (electromagnetic reaction), a sound wave, an electric field, a magnetic field, or pH. Preferably, the termination of a reaction can be controlled by a change of the physical quantity or the chemical quantity. It is possible to control the termination of a reaction by fusing together droplets containing inhibitors that can be bonded to an activating portion of an enzyme, and can deactivate the enzyme, and adding the fused droplets to reaction droplets. With a similar manipulation, it is possible to control the termination of a reaction by fusing strong acid droplets or high-density weak acid droplets into reaction droplets, getting the pH of the droplets out of a proper pH of the enzyme, and degenerating and devitalizing the enzyme. Alternatively, when a proper temperature is 36° C., droplets containing enzymes as the reactive element flow along a flow channel, and the enzymes are held for one minutes or greater at a temperature of 80° C., are degenerated, and are devitalized, it is possible to control the termination of a reaction by keeping a partial region of the flow channel at a temperature of 100° C., and controlling the droplets to pass through the partial region over one minute or greater.

At this time, the reaction termination process refers to a period from the start of each step to the termination thereof; a period from the start of addition of a substance, to the mixture of the substance with the entirety of reaction droplets, then to an actual stop of the entire reaction; or a period from the start of a change in each physical quantity or each chemical quantity to an actual stop of the entire reaction.

The droplets 106 maybe formed using various methods that are well known to persons skilled in the art, or the droplets 106 may be formed using a passive droplet formation method, an active droplet formation method, or a combination of the passive droplet formation method and the active droplet formation method. For example, flow forcusing disclosed in JP-T-2010-506136, or a T-junction disclosed in Lab on a Chip (2006), vol. 6, pp. 437-446 can be used as the passive droplet formation method. A method disclosed in Lab on a Chip (2010), vol. 10, pp. 816-818 maybe used as the active droplet formation method, and more specifically, it is possible to control the volume of the micro droplets 106, and to discharge the droplets 106 via various nozzles by controlling an opening and closing time of a valve provided in or outside the microfluidic device 101, and a difference in pressure before and after the valve.

In any one of the droplet formation methods, at least two immiscible fluids are used. The examples of the immiscible fluid are polar molecules such as water, oil, and a fluid such as ion liquid, and three groups of these fluids are not immiscible with each other. When typical organic molecules containing hydrocarbons and fluorocarbons in oil are properly and selectively combined together, the organic molecules and the fluorocarbons are immiscible with each other. Gas immiscible with the above-mentioned liquid may be used. A continuous phase or a non-continuous of any one of the above-mentioned fluids is used. In the structure illustrated in the above-mentioned droplet formation methods, for example, in a flow forcusing structure, a T-junction, and various nozzles, the continuous phase and the non-continuous phase are confluent with each other, the non-continuous phase is divided into the continuous phase, and the droplet 106 are formed. Typically, the structure used for this confluence is provided in the microfluidic device 101. A fluid to be formed into a continuous phase and a fluid to be formed into a non-continuous phase are introduced via inlets 11 and 12 of the microfluidic device 101. The fluid may be introduced while the analysis system is in use, for example, while an analysis is in progress, or before the analysis system is in use. Typically, exclusive inlets may be respectively assigned to two or more fluids. The microfluidic device 101 may include valves, and the different fluids may be respectively stored in different reservoirs by switching the valves whenever the fluids are introduced, and different immiscible fluids may be delivered from the reservoirs for use, and may be confluent with each other.

Preferably, the reactive elements in the droplets 106 are rapidly mixed immediately after being added into the droplets 106, and thereby the reactive elements are homogenized. As described above, it is possible to start a reaction by adding and mixing the reactive elements; however, when the added reactive elements are homogeneously mixed in the droplets 106, it is possible to make reactive conditions in the droplets 106 uniform, and it is possible to obtain a uniform measurement result even though measuring the characteristics of a certain portion of the droplets 106. Accordingly, it is possible to minimize a difference between an actual reaction time and an intended reaction time and a difference between various actual reactive conditions and intended reactive conditions.

The reactive elements may be mixed due to the properties alone of the micro droplets 106. The micro droplets 106 have effects of promoting the mixing of the reactive elements. The reason for this is that since the droplet 106 has a relatively micro space compared to atypical reaction container, even when the reactive elements are mixed via diffusion alone, the mixing can be completed in a very short time. A vortical flow in the droplet 106 has effects of promoting the mixing. In addition, as described in Journal of the American Chemical Society (2003) vol. 125 pp. 14613-14619, the reactive elements may pass through a flow channel through which the droplets 106 are formed and then coast or a flow pass having irregularity on the wall thereof, and at this time, since the vortical flows in the droplets 106 become more remarkable, and stir the liquid, the mixing can be completed in a much short time period.

The reactive elements may be mixed in a state where droplets are not formed (in a continuous flow state). At this time, a well-known flow channel having a structure for the promotion of mixing may be used.

When a fluid containing the reactive elements is mixed, the fluid may be mixed prior to the formation of droplets, or after a plurality of droplets containing the reactive elements, respectively, are formed, liquid may be mixed by fusing together the droplets. The above-mentioned mixing methods may be combined as follows: a part of the reactive elements are mixed before droplets are formed, and after droplets of the mixed liquid and droplets of the remaining elements are formed, the liquid may be mixed by fusing together, the droplets. For example, at this time, it is possible to reduce an actual time required for mixing liquid by pre-mixing the reactive element which has a relatively, small diffusion coefficient and it takes a time to mix, and by finally mixing the reactive element which has a relatively large diffusion coefficient and can be mixed in a short time period.

[(2) Reaction Time]

A reaction time is defined as a period from a reaction start time of each of the reaction droplets 106 to a reaction termination time thereof. It is possible to control the reaction time by controlling the reaction start time or the reaction termination time.

The reaction start time refers to the formation time of each of the reaction droplets 106, or the reaction start time of each of the reaction droplets 106. More specifically, the reaction start time refers to the mixing start time of the reactive elements, mixing completion time, or a representative time therebetween. Alternatively, the reaction start time may be the formation start time of the reaction droplet 106. Similarly, the reaction termination time may be the start time or the termination time of the reaction termination process, a time representative of a time period of the process, or an analysis time. The analysis time is a time for measuring the characteristics of the reaction droplets 106 required for analyzing the reaction droplets. When the reaction droplets 106 are analyzed, that is, various characteristics of the droplets 106 are measured in a state where reactions in the droplets 106 remain stopped, substantially the same analysis results as in the case in which the reactions are terminated concurrently at the measurement time are obtained, and thereby it is possible to use the analysis time as the reaction termination time. The analysis time as the reaction termination time may be the measurement start time or the measurement termination time of each of the droplets 106, or a time representative of a time period from the start time to the termination time. Preferably, the reaction start time and the reaction termination time is properly selected among the above-mentioned examples, while taking into consideration the type of a reaction, the type of an analysis, an object, or the like, and times other than the above-mentioned examples may be used.

For example, non-continuous phase of water is injected via the first and second inlets, and continuous phase of oil is injected via a third inlet at a given volumetric flow rate that is properly selected. An aqueous solution containing an enzyme and a buffer is injected via the first inlet, and an aqueous solution containing a substrate and a buffer is injected via the second inlet. Flow channels continuing from both the inlets are confluent with each other at a confluence point, and then are confluent with a flow channel continuing from the third inlet while forming a T-junction. A given volume of water droplets are formed at the T-junction at given intervals. When the mixing of the enzyme and the substrate starts at the confluence point can be considered as the start of reactions (the reactions of a part of the droplets). Thereafter, the droplets 106 are formed at the T-junction, and in this example, when the content of the, droplets 106 mixes completely while the droplets 106 flow through the flow channels, the reaction start is actually completed. In comparison of a flow velocity, the size of the droplet, and a reaction velocity, it is possible to considerably reduce the time from the confluence to the formation of the droplets 106 by making the confluence point and the T-junction considerably short. Since the mixing of the liquid occurs much rapidly after the formation of the droplets 106, the reaction can be completed in a short time period to such an extent as to consider that the reaction start time (confluence) is substantially the same as the reaction completion time (the completion of mixing). At this time, even though any one of the above-mentioned reaction start time is adopted, there is no adverse impact. When the velocity of the adopted reaction is considerably high, or when the velocity of mixing in the droplet 106 is sufficiently high due to the characteristics of the solution used, the volume of the droplet 106, a restriction of the flow channel 105 or the volumetric flow rate, a difference between the reaction start time (confluence) and the reaction completion time (the completion of mixing) affects the reaction time, and thereby the reaction completion time may be adopted. An intermediate point between the start and the completion of the reaction, or an estimated value (the value being obtained by a calculation) of the time for a halfway completion of the mixing may be used as a time for the halfway completion of the reaction. It is possible to obtain, the reaction product by time-integration of the reaction velocity by obtaining a change over time in the reaction velocity during the reaction, for example, a change over time in the degree of mixing, from an experiment or a calculation based on a theory. At this time, when it is assumed that the reaction velocity immediately after the start of the reaction is always equal to the reaction velocity after the completion of the reaction, an imaginary reaction start time, at which the quantity of the reaction products is the same as actual quantity, is obtained, and can be used as the reaction start time.

In the above-mentioned example, the reaction termination process is not particularly provided, and it is possible to measure absorbance for a specific wave of light of the droplet 106 which flows through the flow channel 105, via an analysis. At this time, the reaction time is actually equal to the transit time of the droplet 106 from a reaction start point to an analysis start point. It is possible to obtain the transit time of the droplet 106 via a calculation, an experiment, or the measurement of an actual transit time. In the calculation of the transit time, it is possible to estimate the transit time, from a volumetric flow rate and a flow channel volume. It is possible to use an arbitrary volumetric flow rate. For example, it is possible to flow liquid into the microfluidic device 101 at an arbitrary given volumetric flow rate using a syringe and a syringe pump. The flow channel volume may be calculated from the known sizes (the length, the inner diameter, the height and the width of the cross section, the stroke volume, the dead volume, and the like) the flow channel 105, or may be experimentally measured. For example, experimentally, the flow channel volume may be calculated by flowing a fluid through a certain volume at a given volumetric flow rate, and by measuring the time required for passing through the volume from an observation with the eyes or an image captured by camera. Alternatively, a flow channel volume is fully filled with a certain liquid, another second liquid immiscible with the liquid is injected into the flow channel volume, and the flow channel volume may be determined as the volume of the second liquid that is injected until the passing of the second liquid ends after the second liquid start passing through the volume.

Alternatively, the transit time of the droplet is experimentally measured, and may be used to obtain the reaction time. For example, a non-continuous phase is allowed to pass through a certain volume at a given volumetric flow rate, the time required for passing through the volume is measured, and the measured time may be determined as the transit time of the droplet 106. More preferably, a continuous phase is allowed to flow the actual flow channel 105 or an equivalent flow channel at an actual volumetric flow rate, and the transit time of the droplet 106 that flows through the flow channel is measured, and may be used as the transit time. Still more preferably, the value of each of the following parameters is set to be an actual value or a range of values, and a transit time measured via an experiment may be used: the actual, size of the droplet 106; the viscosities of a continuous phase and a non-continuous phase and a ratio therebetween; surface tension between the continuous phase and the non-continuous phase; the wettability of the continuous phase and the non-continuous phase to the wall of the flow channel 105; the volumetric flow rates of the continuous phase and the non-continuous phase; and the like. The reason for adopting this approach is that these parameters may affect the transit velocity of the droplet 106. For example, Lab On a Chip (2011), vol. 11, pp. 3603-3608 discloses the fact that the transit velocity of the droplet 106 is dependent on the relative length l/w (w is the width of the flow channel, and l is the length of the droplet) of the droplet 106 with respect to the flow channel 105, and the ratio between the viscosities of a continuous phase and a non-continuous phase, a capillary number Ca, and the like. Ca is a dimensionless number defined by

Ca=μV/γ

Here, μ [N·s/m²] is the coefficient of viscosity of the fluid, V [m/s] is the representative velocity of the non-continuous phase, and γ [N/m] is surface tension between the continuous phase and the non-continuous phase. According to the above-mentioned method, when an arbitrary volumetric flow rate is given, it is possible to obtain the transit time of the droplet 106. It is possible to control the reaction time by controlling the transit time based on this fact.

### [(3) Transportation of Droplets]

The present invention provides means for transporting the droplets 106 formed in the microfluidic device 101 to the analysis apparatus 103. The microfluidic device 101 is connected to the above-mentioned pipeline 102 via the above-mentioned connection portion 104. Accordingly, the droplets 106 are transported from the microfluidic device 101 to the analysis apparatus 103 via the connection portion 104 and the pipeline 102. The flow channel 105 of the microfluidic device 101 is fluidic connected to the fluid path of the pipeline 102, and the flow channel and the fluid path form an integrated fluid path. The droplets 106 flow in a continuous phase of oil that flows through the integrated fluid path. As described above, a continuous phase of flow is controlled, and thereby it is possible to control the transportation velocity of the droplets 106, the time when the droplets 106 arrive at the analysis apparatus 103, or the analysis time. The transportation path may be one path, or may have branches or a confluence. When there are branches or a confluence, it is possible to use a programmed control method, or a stochastic control method.

### [(4) Analysis of Droplets]

The analysis includes the measurement of various characteristics (one or a plurality of characteristics) of the droplets 106. In addition, the analysis includes the obtainment of a pair of a plurality of absolute characteristics values and a plurality of relative characteristics values via the measurement.

The unlimited examples of the characteristics of the droplets 106 include fluorescence, absorption, spectrum (for example, optical absorption, luminescence, or various scattering in visible light, infrared light, ultraviolet light, or terahertz waves, resonance spectrum, or nuclear magnetic resonance spectrum), radioactivity, mass, volume, density, temperature, viscosity, electromagnetic characteristics (conductivity, dielectric constant, magnetic permeability), pH, the concentration of a substance such as a chemical substance or a biological substance (for example, protein, nucleic acid), or the like. In the measurement of the characteristics, the characteristics of one droplet 106 may be measured once, or after the characteristics are measured plural times, a representative value such as an average value maybe calculated, or the distribution of the characteristics of the droplet 106 may be evaluated.

More specifically, the measurement may be performed using various photometers such as atomic absorption, an absorptiometer, a fluorophotometer, a spectroscope, a mass spectrometer (MS), a nuclear magnetic resonance apparatus (NMR), emission spectrochemical analysis (ICP), HPLC, various microscopes, or the like.

When a continuous phase separating the droplets 106 indicates values different from the characteristics values of the droplets, particularly, the characteristics are almost not detected, the continuous phase acts as a spacer that time-series divides the measured characteristics values of the plurality of droplets. Specifically, when the characteristics values of the plurality of droplets 106 are plotted with respect to time, the values show a peak shape or a pulse shape. Accordingly, the droplet 106 and the measured characteristics value can be easily associated with each other.

[Terminology]

In this specification, a part or the entirety of the flow may be a laminar flow or a turbulent flow, and the flow may be an electroosmotic flow, a pressure driven flow, and the like. The pressure driven flow may be driven by a syringe and a syringe pump, and may be driven by a pressure source that is formed of an air pump, a combination of a pump and a valve, or the like.

In this specification, typically, the oil may be various types of oil or general oil, and for example, vegetable tallow; mineral oil; hydrocarbon oil (normal chain hydrocarbon oil, or aromatic hydrocarbon oil); fluoric oil (fluorocarbon oil or the like), or the like can be used. More preferably, perfluorodecalin, or Fluorinert (a trademark) (FC-40, FC-3283, or the like, 3M Ltd.) may be used. A mixture of various types of oil and a surfactant may be used. It is possible to use various surfactants adapted for a constitutive substances (for example, the oil, a target for analysis, or a solvent) of a droplet. The following surfactants may be used: a non-ionic surfactant such as Tween 20 or NP-40; or a fluorine-based surfactant such as 1H,1H,2H,2H-Perfluoro-1-octanol or EA surfactant (Raindance Ltd.).

In this specification, the water may be various aqueous solutions having water as a constituent, other than pure water.

In this specification, the continuous phase is the phase of a fluid that actually fills a continuous space which takes up the majority of a flow channel.

In this specification, the droplet is a lump of fluid having a given actual mass which is surrounded by the structure (for example, the wall) of a flow channel, or a continuous phase. Typically, the droplet has a ball shape, an elliptical shape, a bullet shape, a circular cylindrical shape, or the like. When the cross-sectional area of a flow channel is small compared to the volume of a droplet.

In this specification, a non-continuous phase is the phase of a fluid that forms a droplet.

In this specification, the droplet formation refers to a phenomenon in which a fluid actually, which flows through a continuous space from a non-continuous phase of inlet, is divided by a continuous phase or a wall, and independent lumps having a given actual mass occur.

In this specification, the continuous flow refers to the flow of a fluid containing only any one of a continuous phase and a non-continuous phase, or the flow of a fluid containing only any one of oil and water.

### EXAMPLE 1

The present invention is to provide a system in which reaction droplets containing an enzyme are prepared, the substrate concentration of the droplets and a reaction time are controlled, and the concentration of a substrate or a reaction product in the droplet is measured. In addition, the present invention is to provide a method of analyzing enzyme, reaction kinetics in the droplet.

For the formation of droplets, a liquid mixture (mixture ratio 10:1 (v/v), both are made by Sigma-Aldrich Ltd.) of perfluorodecalin and 1H,1H,2H,2H-Perfluoro-1-octanol was used as oil that acts as a continuous phase, and water was used as a non-continuous phase. Swine trypsin and peptide ACTH18-39 (Adrenocorticotropic Hormone Fragment 18-39 human, amino acid sequence RPVKVYPNGAEDESAEAFPLEF) (both are made by Sigma-Aldrich Ltd.) were used as an enzyme and a substrate of an analysis target. A buffer (NH₄HCO₃, pH8) was used as a solvent and a diluted solution for adjusting concentration of the enzyme and the substrate. Since the trypsin cuts a specific region of the peptide, a reaction product in this system is peptide having amino acid sequence VYPNGAEDESAEAFPLEF. Equivalent peptide (ACTH22-39) made by Sigma-Aldrich was purchased. Leucine enkephalin (hereinafter, referred to as LeuEnk) was used as a reference substance for quantifying the concentration of the substrate and the reaction product. In order to prepare a calibration curve in advance, ACTH18-39, ACTH22-39, and LeuEnk were mixed at various concentration levels, and were analyzed using a mass spectrometer.

FIG. 21 is a schematic view of the system of the example. A microfluidic device 2201 includes a micro flow channel 2205 that is formed in a silicon wafer as a groove using deep etching; inlets 2211 to 2214 as through-holes; and a discharge port 2215. The microfluidic device was made by bonding together the silicon wafer and a glass wafer using anodic bonding, and then by dicing the bonded wafers. Syringes 2221 to 2224 are respectively connected to the inlets 2211 to 2214 via capillaries 2225 to 2228. The syringe 2221 is filled with 784 μM ACTH18-39, 196 μM LeuEnk, 22.5 mM NH₄HCO₃ aqueous solution as a substrate solution, the syringe 2222 is filled with 22.5 mM NH₄HCO₃ aqueous solution as a diluted solution, the syringe 2223 is filled with 0.43 μM trypsin, 100 μM HCI aqueous solution as an enzyme solution, and the syringe 2224 is filled with oil. A capillary 2202 made of fused quartz is fluidic connected to the discharge port 2215 via a connection portion 2204. The other end of the capillary 2202 is connected, via a union 2229, to a capillary made of stainless steel which is an ion source 2230, and includes a mass spectrometer 2233. (made by Waters Ltd., Synapt HDMS). A specimen that flows into the ion source 2230 is ionized using electrospray, and is transformed into an ion 2231, and the ion 2231 is introduced into a mass analysis unit 2232, and the mass of ion 2231 is measured at a unit of m/z. A fluorine coating was applied to each of the wall surface of the flow channel 2205 of the microfluidic device 2201, and the inner surface of the capillary 2202.

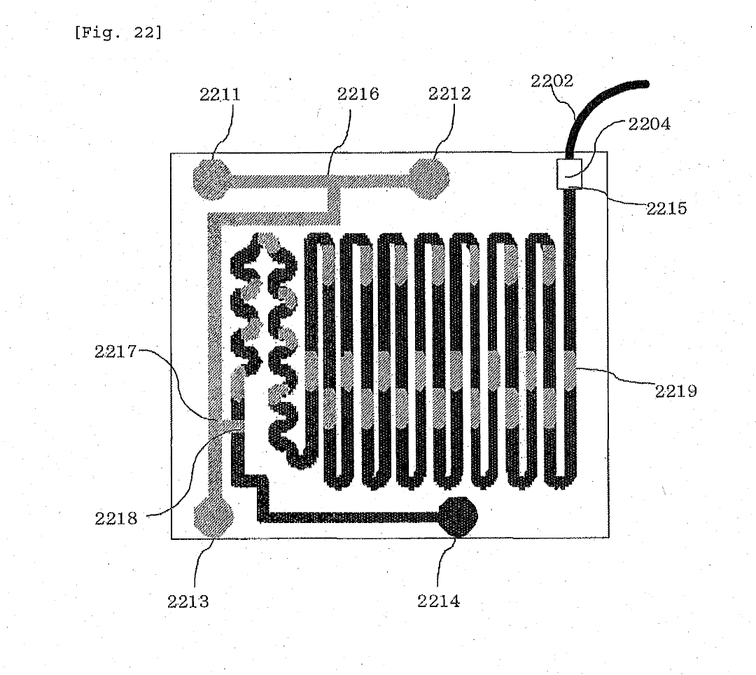

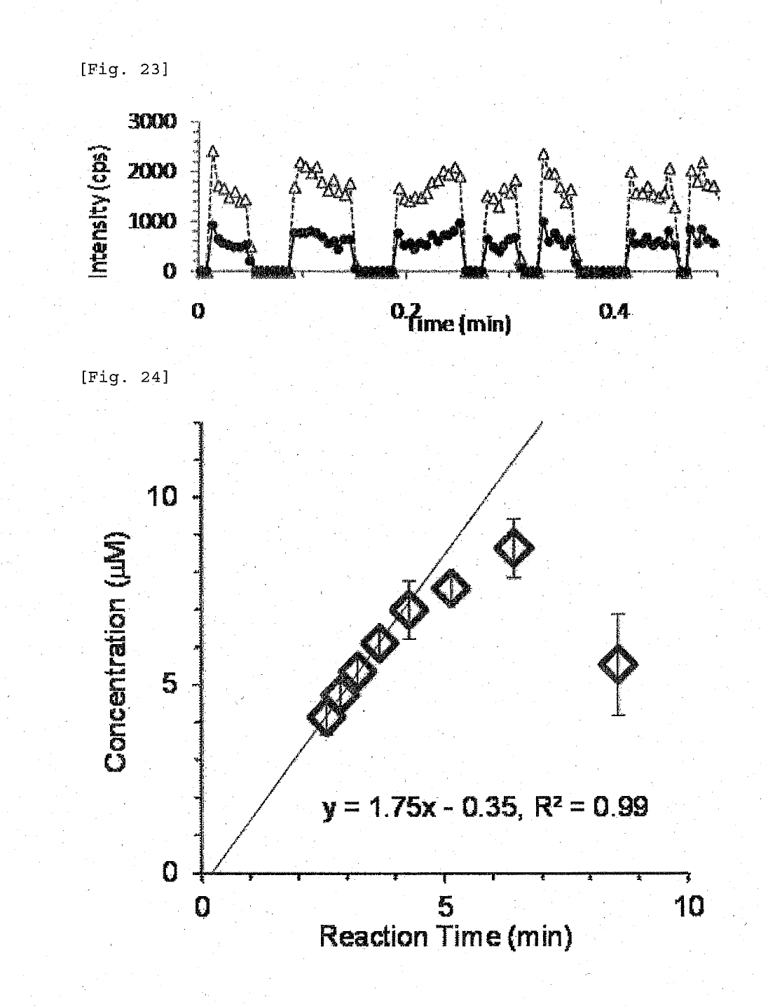

Subsequently, the operation of the microfluidic device 2201 will be described. In FIG. 22, the microfluidic device 2201 is illustrated in detail. The substrate solution and the diluted solution are respectively injected via the inlet 2211 and 2212, and are confluent with each other at a T-junction 2216, and are mixed together. The mixture liquid of the substrate solution and the diluted solution are confluent with the enzyme solution (injected via the inlet 2213) at a T-junction 2217, and then becomes reaction mixture liquid. At a T-junction 2218, the reaction mixture liquid is confluent with the oil that flows into the microfluidic device 2201 via the inlet 2214 immediately thereafter, and is divided by the oil, and droplets (reaction droplets) 2219 are formed. The droplets, 2219 flow through the flow channel 2205, and flow in an orderly row from the discharge port 2215 to the capillary 2202 via the connection portion 2204. Finally, the droplets 2219 are ionized in the ion source 2230, and are analyzed using the mass spectrometer 2232. The composition of the droplet 2219 at the formation thereof is controlled by the flow rate of each solution. For example, when a flow ratio between the substrate solution, the diluted solution, and the enzyme solution is 4:4:1, the composition becomes 382 nM trypsin, 348 μM ACTH18-39, 174 μM LeuEnk, and 20 mM NH₄HCO₃. A reaction time is defined as a time period from the formation of the mixture droplets to the ionization of the droplets in the ion source 2230, and the reaction time can be controlled via a total flow rate including the flow rate of the oil. While the flow ratio between the reaction mixture solution and the oil remained 9:10, when the total flow rate was changed in a range of 3 to 10 μL/min, the reaction time was in a range of 2.6 to 8.6 minutes. FIG. 23 illustrates the data obtained in this manner. From a mass spectrum that was obtained by analyzing the droplets 2219 and the oil using the mass spectrometer 2233, a circle indicates a signal intensity corresponding to ACTH18-39, and a triangle indicates a signal intensity corresponding to LeuEnk. The reason for the formation of the pulse shape of each signal is that signals are obtained only while the droplets 2219 flow into the ion source and are ionized, signals are not obtained while the oil flow into the ion source, and the oil acts as a spacer. That is, one pulse corresponds to one reaction droplet 2219, and thereby it is possible to analyze the composition of each of the droplets 2219. The concentration of each of the substrate and the reaction product is obtained by calculating an average value of intensity ratios between ACTH18-39 and LeuEnk for pulses corresponding to the droplets 2219, and comparing the average value with the calibration curve. In FIG. 24, the concentration of the reaction products in the reaction droplets which are obtained in this were plotted with respect to time. Each point indicates an average value of the concentration of the reaction products for n=73 to 126 droplets (n is the number of droplets). It was possible to obtain an estimated value of reaction velocity of 29.2 nM/s for an initial reaction velocity V0 by determining a regression line for the plot. In the similar sequence, it was possible to obtain an initial reaction velocity by changing the flow ratio between the substrate solution, the diluted solution, and the enzyme solution in a range of 1:7:1 to 7:1:1, and by performing the similar analysis in the range of 49 times the concentration ratio. In the similar experiment, it is possible to obtain data indicative of a decrease in substrate concentration and data indicative of a decrease in reaction velocity, by increasing the reaction time or decreasing the enzyme concentration and thus the reaction velocity. From these experiments, it is possible to analyze various reaction velocity constants using a micro reagent.

### REFERENCE SIGNS LIST

11: inlet 1

12: inlet 2

15: discharge port

101: microfluidic device

102: pipeline

103: analysis device

104: connection portion

105: flow channel

106: droplet

200: capillary

201: fluid path of capillary

202: holding ferrule

203: joint

204: connection hole

205: opening of capillary

206: groove (fluid path)

207: opening of flow channel

208: opening of joint (close to flow channel)

209: silicon layer

210: glass layer

211: opening of joint (close to pipeline)

213: ideal fluid path

221: end surface of capillary

401: fluid path of capillary

402: holding ferrule

404: connection hole

405: opening of capillary

407: opening of flow channel

408: opening of joint (close to flow channel)

409: silicon layer

410: glass layer

411: opening of joint (close to pipeline)

412: additional dead volume

413: ideal fluid path

503a, 503b: joint

504a, 504b: connection hole

505a, 505b: opening of capillary

506a, 506b: groove (fluid path)

507a, 507b: flow channel of microfluidic device

508a, 508b: opening of joint (close to flow channel)

509a, 509b: silicon layer of microfluidic devices

603: joint

606: fluid path of joint

608: opening of joint (close to flow channel)

611: opening (close to pipeline)

714: holder upper portion

715: holder lower portion

716: nut

717: screw

804: connection hole

805: flow channel

806: groove (fluid path)

809: silicon layer

810: glass layer

811: opening of joint (close to pipeline)

818: flow channel

819: groove (fluid path)

903: joint

906: groove (fluid path)

908: opening of joint (close to flow channel)

911: opening of joint (close to pipeline)

922: stepped portion of joint

1103: joint

1106: groove (fluid,path)

1108: opening of joint (close to flow channel)

1111: opening of joint (close to pipeline)

1303: joint

1304: connection hole

1306: groove (fluid path)

1308: opening of joint (close to flow channel)

1311: opening of joint (close to pipeline)

1403: joint

1404: connection hole

1406: groove (fluid path)

1408: opening of joint (close to flow channel)

1411: opening of joint (close to pipeline)

1601: microfluidic device

1603: extremity portion of flow channel

1605: flow channel

1607: opening of flow channel

1609: silicon layer

1610: glass layer

1701: microfluidic device

1702: holding ferrule

1703: extremity portion of flow channel

1704: connection hole

1705: flow channel

1707: opening of flow channel

1709: silicon layer

1710: glass layer

1801: microfluidic device

1802: holding ferrule

1803: extremity portion of flow channel

1804: connection hole

1805: flow channel

1807: opening of flow channel

1809: silicon layer

1810: glass layer

1901: microfluidic device

1902: holding ferrule

1904: connection hole

1905: flow channel

1907: opening of flow channel

1909: silicon layer

1910: glass layer

1919: groove of glass layer (leading end portion of flow channel)

2002: holding ferrule

2003: grooved ferrule

2006: groove (fluid path)

2102: grooved holding ferrule

2106: groove (fluid path)

2201: microfluidic device

2202: capillary

2204: connection portion

2205: micro flow channel

2211: inlet 1

2212: inlet 2

2213: inlet 3

2214: inlet 4

2215: outlet

2216: T-junction 1

2217: T-junction 2

2218: T-junction 3

2219: droplet

2221: syringe 1

2222: syringe 2

2223: syringe 3

2224: syringe 4

2225: capillary 1

2226: capillary 2

2227: capillary 3

2228: capillary 4

2229: union

2230: ion source

2231: ion

2232: mass spectrometry portion

2233: mass spectrometer

2234: holder

1. An analysis system comprising:
a microfluidic device that has micro flow channels; and
an analysis apparatus,
wherein the microfluidic device has a first inlet and a second inlet, the flow channels from the inlets are confluent with each other therein, and a fluid injected via each of the inlets is discharged to the analysis apparatus.

2. The analysis system according to claim 1, further comprising:
a pipeline through which the fluid discharged from the microfluidic device is delivered to the analysis apparatus; and
a first connection member that covers the circumference of the pipeline in the vicinity of a discharge port of the microfluidic device.

3. The analysis system according to claim 2,
wherein the first connection member has a through-hole at the center thereof,
wherein the pipeline is inserted into the through-hole while being in close contact with an inner surface of the through-hole, and
wherein the first connection member has a cut away portion that extends in a direction different from the direction of the through-hole, and communicates with the through-hole, and the cut away portion communicates with the flow channel.

4. The analysis system according to claim 2,
wherein the first connection member has a through-hole at the center thereof,
wherein the pipeline is inserted into the through-hole while being in close contact with an inner surface of the through-hole, and
wherein the first connection member has an opening portion that extends in a direction different from the direction of the through-hole, communicates with the through-hole, and continues to a side surface of the first connection member, and the opening portion communicates with the flow channel.

5. The analysis system according to claim 2, further comprising:
a gap that is formed between the pipeline and a lower surface of the flow channel of the microfluidic device.

6. The analysis system according to claim 2, further comprising:
a ferrule that fixes the pipeline to the microfluidic device.

7. The analysis system according to claim 6,
wherein the ferrule presses the first connection member against the microfluidic device.

8. The analysis system according to claim 2, further comprising:
a holder upper portion that holds the pipeline;
a holder lower portion that holds the microfluidic device; and
screws between which the holder upper portion and the holder lower portion are interposed.

9. The analysis system according to claim 8, further comprising:
a ferrule that fixes the pipeline to the microfluidic device; and
nuts that press the holder upper portion against the ferrule.

10. The analysis system according to claim 3, further comprising:
a plurality of the cut away portions that are separated from each other.

11. The analysis system according to claim 4, further comprising:
a plurality of the opening portions that are separated from each other.

12. The analysis system according to claim 3,
wherein the through-hole has a stepped portion, and an end surface of the pipeline is positioned in the stepped portion.

13. The analysis system according to claim 1,
wherein the microfluidic device is formed by bonding a first layer member and a second layer member together,
wherein the analysis system further comprises,
a pipeline through which the fluid discharged from the microfluidic device is delivered to the analysis apparatus, and
a second connection member which is positioned between the pipeline and the second layer member in the vicinity of an outlet of the microfluidic device, and through which the fluid is delivered from the flow channel to the pipeline, and
wherein at least the flow channel of the second connection member has substantially the same inner diameter as that of the pipeline, the flow channel being disposed in the same direction as the pipeline.

14. The analysis system according to claim 13,
wherein a part of the second connection member extends to an outer circumference of the pipeline.

15. The analysis system according to claim 13,
wherein an outer diameter of the second connection member is the same as that of the pipeline.

16. The analysis system according to claim 13,
wherein the second connection member has a through-hole at the center thereof,
wherein the pipeline is inserted into the through-hole while being in close contact with an inner surface of the through-hole, and
wherein the second connection member has a cut away portion that extends in a direction different from the direction of the through-hole, and communicates with the through-hole, and the cut away portion communicates with the flow channel.

17. The analysis system according to claim 13,
wherein the second connection member has a through-hole at the center thereof,
wherein the pipeline is inserted into the through-hole while being in close contact with an inner surface of the through-hole, and
wherein the second connection member has an opening portion that extends in a direction different from the direction of the through-hole, communicates with the through-hole, and continues to a side surface of the first connection member, and the opening portion communicates with the flow channel.

18-24. (canceled)

25. The analysis system according to claim 1, further comprising:
a pipeline through which the fluid discharged from the microfluidic device is delivered to the analysis apparatus,
wherein the microfluidic device is formed by bonding a first layer member and a second layer member together,
wherein the first layer member has a through-hole,
wherein the pipeline is inserted into the through-hole, and
wherein the second layer member has a groove in the vicinity of the pipeline.

26. The analysis system according to claim 1, further comprising:
a pipeline through which the fluid discharged from the microfluidic device is delivered to the analysis apparatus,
wherein the microfluidic device is formed by bonding a first layer member and a second layer member together,
wherein the first layer member has a through-hole and a flow channel,
wherein the pipeline is inserted into the through-hole,
wherein the second layer member has a groove in the vicinity of the pipeline, and
wherein the groove communicates with the flow channel.

27. The analysis system according to claim 25, further comprising:
a ferrule that is disposed between the pipeline and the microfluidic device so as to fix the pipeline to the microfluidic device, and that is provided with a groove.

28-37. (canceled)

38. The analysis system according to claim 16,
wherein the second connection member is attachable and detachable with respect to the microfluidic device.

39-42. (canceled)
